(19) United States
(12) Patent Application Publication
(10) Pub. No.: US 2024/0360295 A1
(43) Pub. Date: Oct. 31, 2024

(54) STABILIZER COMBINATION FOR PREVENTING DEGRADATION OF SYNTHETIC POLYMERS

(71) Applicant: BASF SE, Ludwigshafen am Rhein (DE)

(72) Inventors: Cinzia TARTARINI, Pontecchio Marconi (IT); Raphael DABBOUS, Kaisten (CH); Jorge ESPINOS ARIZTI, Barcelona (ES); Guo Liang YUAN, Shanghai (CN)

(21) Appl. No.: 18/688,474

(22) PCT Filed: Aug. 11, 2022
(86) PCT No.: PCT/EP2022/072600

§ 371 Date: Mar. 1, 2024

(30) Foreign Application Priority Data
Sep. 2, 2021 (WO) PCT/CN2021/116201

(51) Int. Cl. C08K 5/1535; C08J 9/00; C08K 5/10; C08K 5/134; C08K 5/1545; C08K 5/18; C08K 5/524

(52) U.S. Cl. CPC C08K 5/1535; C08J 9/0023; C08J 9/0028; C08J 9/0038; C08J 9/0095; C08K 5/10; C08K 5/134; C08K 5/1545; C08K 5/18; C08K 5/524; C08J 2375/04

(57) ABSTRACT

The invention relates to a composition, which comprises the components (i) a synthetic polymer; and (ii) a ternary stabilizer combination comprising a benzofuranone, a sterically hindered phenol compound such as a bisphenolic stabilizer and an aliphatic phosphorous (III) compound. A process for manufacturing the aforementioned composition, the use of a stabilizer combination as component (ii) for stabilizing synthetic polymer component (i) against degradation and the use of a stabilizer combination (ii) for stabilizing synthetic polymer (i). As well described are further specific additive mixtures comprising these components and e.g. aminic and/or phenolic and/or chromanol-based antioxidants as further components.

The present invention relates to a composition comprising polyether polyol or polyurethane (PU), as component (i), and as component (ii) a stabilizer combination based on (ii.1) a benzofuranone derivative such as a 3-Phenyl-benzofuran-2-one derivative, (ii.2) a sterically hindered phenol such as a bisphenolic stabilizer, and (ii.3) an aliphatic phosphorous (III) compound such as a phosphite or phosphonate ester. The present composition is suited to prevent oxidative, thermal or light-induced degradation of a synthetic polymer. The current invention relates as well to a process for manufacturing the aforementioned composition, the use of the specific stabilizer combination (ii) for stabilizing the component (i)

### BACKGROUND OF THE INVENTION

Polyurethane foam is commonly used as a material in application areas like home furniture, automotive interior or construction. These are application areas, in which long-lasting operation times of the employed materials are desired. This might be contrasted to the application area of packaging in case of one-time packaging for protection of packaged goods against a mechanical shock. Like many organic materials, polyurethane itself and particularly polyurethane foam is susceptible to degradation caused by exposure to energy or chemically reactive species. There is on one side already the initial exothermic reaction of the starting materials polyol and di- or polyisocyanates forming the polyurethane foam itself and on the other side the long-term exposure towards heat and/or light during its operating time. The initial exothermic reaction of the starting materials for the polyurethane foam is conducted under conditions, where a foaming agent generates a blowing gas. In case of water as a foaming agent, the reaction with an isocyanate for releasing carbon dioxide is additionally exothermic. A polyether polyol is often used as a polyol starting material of a polyurethane foam, if a polyurethane foam with a soft foam consistency is desired. A polyether polyol is itself already an organic material susceptible to degradation caused by exposure to energy or chemically reactive species. If a polyether polyol is employed already in a marred state as a starting material for a polyurethane foam, then this is not beneficial for resistance of the formed polyurethane foam against future exposure to energy or chemically reactive species.

Anti-scorch performance for additives used in Polyether polyols and in PU foams is needed to guarantee Polyol stability during storage and transportation. In addition, and even more importantly, anti-scorch systems are used to preserve PU foams from degradation during the exo-thermic foam production process, resulting in discoloration and loss of mechanical properties. This degradation is well-known in the industry and referred to as ‘scorch’. In extreme cases, an uncontrolled exothermic reaction during the foaming process can even result in a fire. For this reason, the protection against scorch and degradation during the foam process is of primary importance.

Over the years, additional undesired properties like discoloration upon gas fading exposure as well as light-induced discoloration, which are considered secondary properties, have become of increasing importance.

With the automotive industry setting more and more stringent standards (e.g. VDA 278 10/2011, which describes procedures for the determination of volatile organic compounds (VOC) and semi-volatile organic compounds (SVOC or FOG) in car-trim materials, along with associated standards to ensure instrument performance and allow semi-quantitation) to control and reduce emissions from volatile and semi-volatile organic compounds in interior applications, the attention to emissions from PU foams used in motor vehicles has become of greater importance. In Asia, countries like China, Japan and Korea upgraded the standards for emissions in automotive interiors especially by monitoring the release of aldehydes and aromatic compounds (see e.g. China's automotive standard GB 27630).

Anti-scorch additives in liquid form are usually preferred in the industry due to their easier incorporation in the liquid raw materials used to produce polyurethane foams.

Sterically hindered phenols, aromatic amines and phosphites in liquid form typically used in the industry often contribute to emissions. In addition, when using aromatic amines, a negative impact on PU foams storage discoloration is observed.

An objective of this present invention is to describe a novel anti-scorch composition based on a benzofuranones, an sterically hindered phenol and an aliphatic phosphorous (III) compound preferably in liquid form, which provides scorch protection, low emissions according to stringent automotive emissions standards as well as reduction of aldehyde emissions from Polyol and PU foams. Another advantageous feature is a low PU foams discoloration upon storage when using the novel stabilizer compositions according to the present invention.

### DETAILED DESCRIPTION OF THE INVENTION

The current invention relates to a composition comprising as
component (i) a synthetic polymer selected from
   a polyurethane foam or a polyether polyol, and as
component (ii) a ternary stabilizer combination comprising as
   component (ii.1) at least a substituted benzofuranone derivative, preferably a 3-Phenyl-benzofuran-2-one derivative,
   component (ii.2) at least one sterically hindered phenol, preferably a bisphenolic stabilizer,
   and
   component (ii.3) at least an aliphatic phosphorous (III) compound, preferably an aliphatic phosphite (di)ester compound.

Individual components as described above and compositions comprising them have been described for preventing synthetic polymers to be subject to oxidative, thermal or light-induced degradation.

For instance, the preparation and use of benzofuranone derivatives as stabilizers in polymers have been reported in several documents.

EP 1291384 discloses the application of a benzofuranone substituted with an acetoxy-substituted phenyl as depicted below as a stabilizer of a polyurethane foam based on a polyether polyol. It is found superior regarding discoloration of the stabilized foam versus a comparative benzofuranone substituted with a phenyl, which is solely substituted by two C₁-alkyl groups, as depicted below.

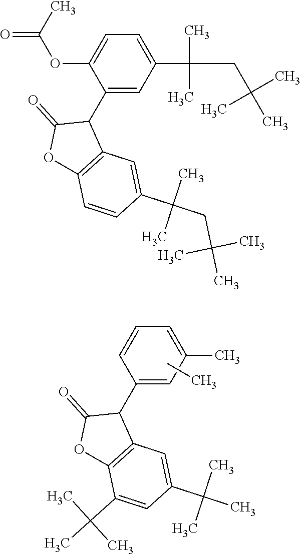

More in detail, examples based on combinations with octadecyl-3-(3,5-di-tert.butyl-4-hydroxy-phenyl)-propionate and the solid aromatic phosphite derivative tris(2,4-di-tert-butylphenyl) phosphite, as well as combinations of sterically hindered phenol/aromatic amine/benzofuranone and liquid aromatic diphenyl isodecyl phosphite (DPDP) are reported. DPDP is known in the polyurethane industry, however its use is considered unfavorable due to the release of free-phenol and its non-favourable regulatory classification.

WO 2006/065829 describes a novel class of compounds and compositions and synthetic methods related to lactone antioxidant 3-benzofuranones to prevent yellowing of polymers such as polyurethane foams. It discloses the application of a benzofuranone substituted with an alkoxy-substituted phenyl, a main component of it as depicted below, as a stabilizer of a polyurethane foam based on a polyether polyol. It is found superior or equal versus a comparative benzofuranone substituted with a phenyl, which is substituted by two C₁-alklyl groups as depicted below. Furthermore, both benzofuranones are applied as stabilizer of a polyether polyol and a similar performance is described for both.

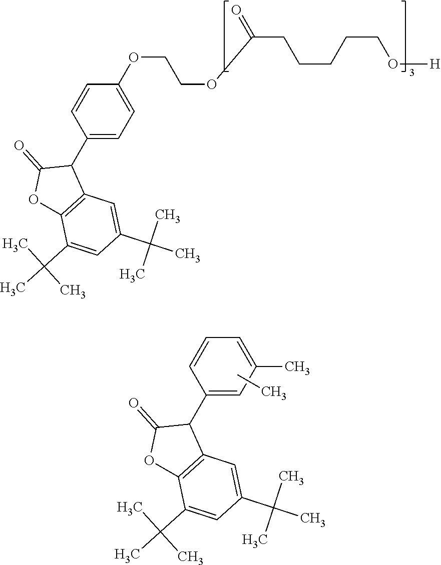

Reported examples include one polymeric lactone in combination with sterically hindered phenol, aromatic amine and UV absorber. However, no combinations with phosphites are specifically described.

WO 2015/121445 discloses benzofuranone phosphite derivatives as a stabilizer for organic materials susceptible to oxidative, thermal or light-induced degradation. Mostly the benzofuranone phosphites described are applied for stabilization of polyethylene or polypropylene. Inter alia, two specific mono-benzofuranone phosphites as depicted below are employed.

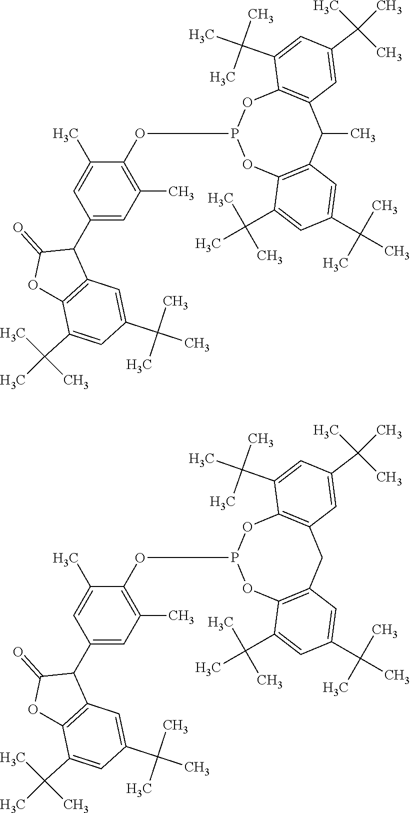 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)C(C)c2cc(C(C)(C)C)cc(C(C)(C)C)c2O1 ; Cc1cc(C2C(=O)Oc3c2cc(C(C)(C)C)cc3C(C)(C)C)cc(C)c1OP1Oc2c(cc(C(C)(C)C)cc2C(C)(C)C)Cc2cc(C(C)(C)C)cc(C(C)(C)C)c2O1]

Examples shows the benzofuranone phosphite derivatives in combinations with Octadecyl-3-(3,5-di-tert.butyl-4-hydroxyphenyl)-propionate and the aromatic phosphite derivative tris(2,4-di-tert-butylphenyl) phosphite.

WO 2017/025431 discloses benzofuranone phosphate derivatives as stabilizers for organic materials susceptible to oxidative, thermal or light-induced degradation. Examples show the stabilization of polyethylene and polypropylene with a specific benzofuranone phosphate derivative.

This specific benzofuranone phosphate is also shown to be more resistant towards exposure to humidity than its specific benzofuranone phosphite counterpart. Another benzofuranone phosphate is also disclosed and depicted below.

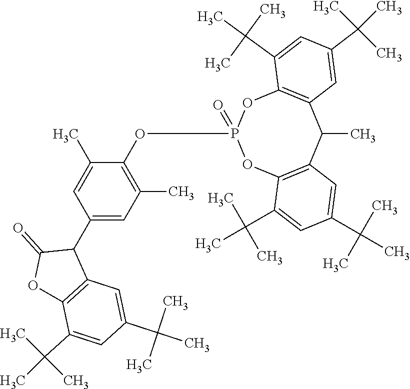 [SMILES: Cc1cc(C2C(=O)Oc3c2cc(C(C)(C)C)cc3C(C)(C)C)cc(C)c1OP1(=O)Oc2c(cc(C(C)(C)C)cc2C(C)(C)C)C(C)c2cc(C(C)(C)C)cc(C(C)(C)C)c2O1]

EP 2500341 describes antioxidant compounds synthesized or derived from benzofuranone compound and benzoic acid compound, which show heat resistance and can be used as additive for polymers to enhance their stability of melting flow and color.

However, no examples show their use in Polyols or Polyurethanes.

WO 2020/002130 describes 3-Phenyl-benzofuran-2-one derivatives containing phosphorus as stabilizers in Polyol and Polyurethanes. Several examples of stabilizers combinations containing benzofuranones are included. Phosphites and phosphonites are mentioned as possible further additives, whereas aromatic phosphites are especially preferred, some of which are used in solid form in the examples.

EP 0871066 describes a colour photographic silver halide material which contains in one layer a benzofuranones derivative for elevated storage stability.

So-called sterically hindered phenols are known in the industry since long time. These are for instance those phenols which attached to the aromatic ring have exactly one phenolic hydroxy group and particularly preferably around such, those that in the ortho positions, most preferably in the ortho- and para-position to the phenolic hydroxy group have a substituent, preferably an alkyl group, in particular to alkyl-3-(3,5-di-tert-butyl-4-hydroxyphenyl) propionate, respectively to substituted alkyl derivatives of such compounds. Their effects are based on steric hindrance, which is a consequence of steric effects. Steric hindrance is the slowing of chemical reactions due to steric bulk and is usually manifested in intermolecular reactions, whereas discussion of steric effects often focusses on intramolecular interactions. These are usually understood by the skilled person as compounds that intercept radicals. Steric hindrance is often exploited to control selectivity, such as slowing unwanted side-reactions. For instance, sterically hindered phenols are used industrially as antioxidants for hydrocarbon-based products ranging from petrochemicals to plastics.

WO17125291 describes stabilizer combinations based on a bisphenolic stabilizer with high molecular weight as sterically hindered phenol in liquid form.

One preferred sterically hindered phenol is the compound as depicted below:

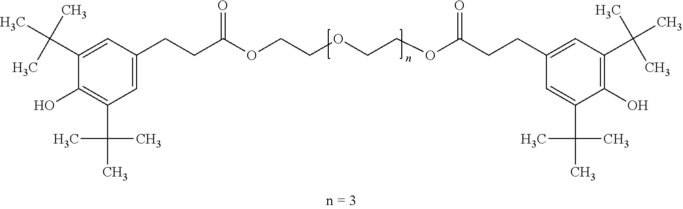

The stabilizers combinations shown in WO17125291 include further phosphites of aromatic origin. However, stabilizer combinations according to the present invention are not described.

Organic compounds of trivalent phosphorous such as phosphites or phosphonates are often used as hydroperoxide decomposers, through their oxidation to phosphate derivatives. Phosphites are known as antioxidants in the industry since long time and several patents describe their use as secondary stabilizers, however in most of the cases these are of aromatic origin and in solid form. For instance, phosphites have been described in combination with sterically hindered phenols. WO 2019/057539 describes the use of di-octyl phosphonate, which is of aliphatic origin and in liquid form, reporting the use in polyisocyanate compositions.

However, no use is reported in Polyol or polyurethane foams.

Despite of a series of already available stabilizer concepts, there is still a need for further technical concepts towards an improved stabilization of a polyurethane foam or a polyether polyol against the detrimental impact of heat, light and/or oxidation. Preferably, the technical concept allows a simplified handling during its application. In addition, in view of the increasing need for sustainable solutions with a good profile under Environmental, Health and Safety criteria, anti-scorch systems leading to reduced emissions are desirable.

It is an object of the present invention to provide an improved stabilization against the detrimental impact of heat, light and/or oxidation.

Particularly, a good resistance against oxidation by oxygen is desired. Particularly, a good resistance against scorching, which is a degradation observed at a material in the form of a foam, is desired.

The object is achieved, according to the invention, by a composition, which comprises the components
(i) a synthetic polymer selected from a polyurethane foam or a polyether polyol; and
(ii) a ternary stabilizer combination comprising at least as
   component (ii.1) a substituted benzofuranone compound, as
   component (ii.2) a sterically hindered phenol, and as
   component (ii.3): an aliphatic phosphorous (III) compound.

Preferably a composition according to the invention comprises as components
(i) a synthetic polymer selected from a polyurethane foam or a polyether polyol; and
(ii) a ternary stabilizer combination comprising at least as
   component (ii.1) a 3-Phenyl-benzofuran-2-one derivative as the substituted benzofuranone compound, as
   component (ii.2) a bisphenolic stabilizer as the sterically hindered phenol, and as
   component (ii.3): an aliphatic phosphite or phosphonate ester as the phosphorous (III) compound.

### The Individual Components of the Composition of the Present Invention

### The Synthetic Polymer (i) According to the Present Invention

The polyurethane and the polyether polyol are both susceptible to oxidative, thermal or light-induced degradation. The compound of formula I is incorporated into the polyurethane foam or the polyether polyol for stabilization of the polyurethane foam or the polyether polyol.

A polyurethane is obtained from the reaction of a polyisocyanate reactant and a polyol reactant in a reaction mixture. For generation of the polyurethane foam, a gas generation takes place during the reaction. The gas generation during the reaction can be caused by an addition of water or a carboxylic acid to the reaction mixture prior to the reaction for a chemical gas generation or by an addition of a blowing agent to the reaction mixture prior to the reaction.

In case of addition of water, a water molecule reacts with an isocyanate group, carbon dioxide eliminates and the formed primary amine reacts with a further isocyanate group to form a urea group:

R^{a}—N═C═O+H₂O+R^{b}—N═C═O→R^{a}—NH—C(═O)—NH—R^{b}+CO₂

In case of addition of a carboxylic acid, the carboxylic acid reacts with an isocyanate group, carbon dioxide eliminates and an amide group is formed:

R^{a}—N═C═O+HO(O═)C—R^{c}→R^{a}—NH—C(═O)—R^{c}+CO₂

A blowing agent as used herein means an organic compound, which has a boiling point at 101.32 kPa of between −15° C. and at or below the maximum temperature generated during the reaction of the reaction mixture, preferably between −15° C. and 110° C., more preferably between −10° C. and 80° C. and very preferably between −5° C. and 70° C. Furthermore, the blowing agent does not react under formation of a chemical bond with the polyisocyanate reactant or the polyol reactant in the reaction mixture under the conditions of the reaction. Examples for a blowing agent are alkanes having from 4 to 10 carbon atoms, preferably 5 to 8 carbon atoms, cycloalkanes having from 5 to 10 carbon atoms, acetone, methyl formate, carbon dioxide (added in liquid form) or partially or fully halogenated alkanes having from 1 to 5 carbon atoms, preferably 1 to 3 carbon atoms.

Alkanes having from 4 to 10 carbon atoms are for example butane, pentane, hexane, or heptane. Cycloalkanes having from 5 to 10 carbon atoms are for example cyclopentane or cyclohexane. Partially or fully halogenated alkanes are for example methylene chloride 1,1,1-trichlor-ethane, CFC-11, CFC-113, CFC-114, CFC-123, CFC-123a, CFC-124, CFC-133, CFC-134, CFC-134a, CFC-141b, CFC-142, CFC-151. From the partially or fully halogenated alkanes having from 1 to 5 carbon atoms, the partially halogenated ones, i.e. those having at least one hydrogen atom, are preferred, for example methylene chloride, CFC-123, CFC-141b, CFC-124 or 1,1,1-trichloroethane.

When water is used for the gas generation, water is preferably added to the reaction mixture prior to the reaction in an amount from 0.5 to 12 parts by weight based on 100 parts by weight of the polyol reactant. More preferably, 1 to 8 parts of water are added. Most preferably, 2 to 7 parts of water are added, for example 3 to 7 or 4 to 7 parts of water. Particularly for a polyurethane foam having a density between 16 and 32 kg/m³, 3 to 8 parts water are added. For a polyurethane foam having a density above 32 kg/m³ and below 48 kg/m³, 2 to 5 parts of water are added.

When a blowing agent is used for the gas generation, the blowing agent is preferably added to the reaction mixture in an amount from 2 to 50 parts by weight based on 100 parts by weight of the polyol reactant. More preferably, 3 to 45 parts of the blowing agent are added. Very preferably, 4 to 30 parts of the blowing agent are added, for example 5 to 25 parts of the blowing agent.

The use of water or a carboxylic acid or the use of a blowing agent provide the desired reduction in density of the polyurethane. When water or a carboxylic acid, particularly water, is used, the reaction exotherm is increased. With the use of water, the amount of urea linkages in the polyurethane foam is increased, which hardens the foam. In contrast, the use of a blowing agent moderates the temperature inside the reaction mixture and softens the foam. Nevertheless, the use of water is attractive but raises the requirements for stabilization of the polyurethane foam, which is generated during the reaction.

A polyurethane foam is for example a normal polyurethane foam or a self-skinning polyurethane foam (structural foam). A normal polyurethane foam possesses the same chemical composition and the same density over a cross section of a structure made out of the normal polyurethane foam. This does of course not apply if such a small scale is chosen that number of void spaces in the cells and the number of the walls of the cells get too small. A self-skinning polyurethane foam (structural foam) possesses the same chemical composition, but the density over a cross section of a structure made out of the self-skinning foam increases from the porous core of the structure towards the outer peripheral zones of the structure. The outer peripheral zones are nearly compact. A normal polyurethane foam is obtained for example by reaction of the reaction mixture in an infinite reaction bin, i.e. the reaction bin is open in a least one direction in the meaning that the emerging foam would not spread significantly further even if the volume of the reaction bin is significantly enlarged. A self-skinning polyurethane foam is for example obtained by reaction of the reaction mixture in a finite reaction bin, i.e. the emerging foam fills the whole volume of the finite reaction bin and the emerging foam would spread significantly further if the volume of the finite reaction bin is enlarged. Furthermore, a temperature gradient exists during the reaction, e.g. by cold surfaces of the finite reaction bin and the uncooled core. By using a blowing agent for the self-skinning polyurethane foam, the formation of a substantially non-cellular skin on the surfaces at the outer peripheral zones of the structure.

The addition of water or a carboxylic acid to the reaction mixture prior to the reaction is preferred, more preferred is the addition of water to the reaction mixture prior to the reaction. Very preferred is the addition of water or a carboxylic acid to the reaction mixture prior to the reaction in case of a normal polyurethane foam. Most preferred is the addition of water to the reaction mixture prior to the reaction in case of a normal polyurethane foam.

The polyurethane foam has a reduced density versus a polyurethane, which is obtained from the same reaction mixture except for a content of water or a carboxylic acid or a content of a blowing agent. The polyurethane foam has preferably a density between 5 to 500 kg/m³ at 20° C. and 101.3 kPa, more preferably between 10 to 300 kg/m³, very preferably 15 to 100 kg/m³ and most preferably 16 to 48 kg/m³. In case the polyurethane foam is a self-skinning foam (structural foam), the density is determined as the average density of the whole foam structure. Often, the density of a self-skinning polyurethane foam is 10 times higher than the density of a normal polyurethane foam.

Preferred is a composition, wherein the polyurethane foam has a density between 5 to 500 kg/m³ at 20° C. and 101.3 kPa.

The polyurethane foam is preferably thermoset.

The polyurethane foam is preferably a semi-rigid cellular material or a flexible (or soft) cellular plastics. More preferably, the polyurethane foam is a flexible (or soft) cellular plastics. A deformation resistance of the polyurethane foam is for example measured according to the norm DIN 53421, wherein a compression stress at 10% compression of 15 kPa or less indicates a flexible cellular plastics. The polyurethane foam is very preferably a flexible (or soft) cellular plastics, which possesses a compression stress at 10% compression of 15 kPa or less according to DIN 53421.

The polyurethane foam is preferably thermoset and a flexible cellular plastics.

A surfactant is preferably added to the reaction mixture prior to the reaction. The surfactant supports the generation of a stable foam from the reaction mixture during the reaction, i.e. a foam which does not collapse until the reaction has progressed to a sufficiently cured stage to maintain is cellular configuration or a foam which does not contain significant quantities of large pores. A surfactant is for example a siloxane derivative, for example a siloxane/poly(alkylene oxide), or a fatty acid salt. Preferably, the surfactant is a siloxane derivative. Since an excess of surfactant tends to cause the reaction mixture to collapse before gelling, the surfactant is preferably added in an amount of 0.05 to 5 parts of weight based on 100 parts of the polyol reactant, more preferably 0.15 to 4 parts, very preferably 0.3 to 3 parts and most preferably 0.8 to 2 parts.

A catalyst for the reaction of a polyisocyanate reactant and a polyol reactant is preferably added to the reaction mixture. The catalyst is for example an amine catalyst or an organometallic catalyst. An amine catalyst is for example triethylenediamine or a derivative based on it, N-methyl morpholine, N-ethyl morpholine, diethyl ethanolamine, N-coco morpholine, 1-methyl-4-dimethylaminoethyl piperazine, 3-methoxy-N-dimethylpropylamine, N,N-diethyl-3-diethylaminopropylamine, dimethylbenzyl amine, bis-(2-dimethylaminoethyl)ether or dimethylbenzyl amine. Preferred is a triethylenediamine or a derivative based on it. An organometallic catalyst is for example an organic salt of tin, bismuth, iron, mercury, zinc or lead. Preferred is an organotin compound. Examples for an organotin compound are dimethyl tin dilaurate, dibutyl tin dilaurate or stannous octoate. Preferred is stannous octoate. Preferably, the amount of an amine catalyst is from 0.01 to 5 parts by weight based on 100 parts by weight of the polyol reactant, more preferably is an amount of 0.03 to 2 parts by weight. Preferably, the amount of an organometallic catalyst is from 0.001 to 3 parts by weight based on 100 parts by weight of the polyol reactant. Preferably, an amine catalyst and an organometallic catalyst are added to the reaction mixture.

The polyisocyanate reactant is an aromatic polyisocyanate or an aliphatic polyisocyanate. An aromatic polyisocyanate is for example 2,4- and/or 2,6-toluene diisocyanate (TDI), 2,4′-diphenylmethanediisocyanate, 1,3- and 1,4-phenylene diisocyanate, 4,4′-diphenylmethane diisocyanate (MDI), 2,4′-diphenylmethane diisocyanate (often contained as a minor isomer in 4,4′-diphenylmethane diisocyanate), 1,5-naphthylene diisocyanate, triphenylmethane-4,4′, 4″triisocyanate or polyphenyl-polymethylene polyisocyanates, for example polyisocyanates as prepared by aniline-formaldehyde condensation followed by phosgenization (“crude MDI”). Mixtures of aromatic polyisocyanates are also included. An aliphatic polyisocyanate is for example ethylene diisocyanate, 1,4-tetramethylene diisocyanate, 1,6-hexamethylene diisocyanate, 1,12-dodecane diisocyanate, cyclobutene-1,3-diisocyanate, cyclohexane-1,3- and 1,4-diisocyanate, 1,5-diisocyanate-3,3,5-trimethylcyclohexane, 2,4- and/or 2,6-hexahydrotoluene diisocyanate, perhydro-2,4′- and/or 4,4′-diphenylmethanediisocyanate (H₁₂MDI) or isophorone diisocyanate. Mixtures of aliphatic polyisocyanates are also included. In addition, derivatives and prepolymers of the foregoing aromatic polyisocyanate or aliphatic polyisocyanate are included, for example these containing urethane, carbodiimide, allophanate, isocyanurate, acylated urea, biuret or ester groups (“modified polyisocyanates”). For an aromatic polyisocyanurate, the so-called “liquid MDI” products which contain carbodiimide groups are an example. It is also possible to employ the isocyanate group-containing distillation residues of aromatic polyisocyanates or aliphatic polyisocyanates, as it is or dissolved in one or more of the abovementioned polyisocyanates, which are obtained in the course of the industrial preparation of isocyanates. Preferred polyisocyanate reactants are the aromatic polyisocyanates TDI, MDI or derivatives of MDI, and the aliphatic polyisocyanates isophorone diisocyanate, H₁₂MDI, hexamethylene diisocyanate or cyclohexane diisocyanate. Very preferred are aromatic polyisocyanates. Most preferred is a polyisocyanate, which is TDI, MDI or a derivative of MDI. Especially preferred is a polyisocyanate, which is TDI, particularly a mixture of 2,4-toluene diisocyanate and 2,6-toluene diisocyanate.

The polyisocyanate reactant is preferably used in an amount to provide an isocyanate index of 90 to 130, more preferably 95 to 115, most preferably 100 to 113 and especially preferably 105 to 112. The isocyanate index is used herein to mean 100 times the ratio of the used isocyanate groups relative to the theoretical equivalent amount needed to react with the active hydrogen equivalents in the reaction mixture, e.g. in the polyol reactant and—if present—in water, carboxylic acid, crosslinker, chain extender and in other components with a functional group, which is an active hydrogen-containing group and thus is reactive towards an isocyanate group. An index 100 indicates a stoichiometry 1 to 1 and an index 107 indicates for example a 7% excess of isocyanate equivalents. Isocyanate equivalents are the overall number of isocyanate groups. Active hydrogen equivalents means the overall number of active hydrogens. An active hydrogen-containing group, which is a hydroxyl group or a secondary amine group, contributes one active hydrogen equivalent. An active hydrogen-containing group, which is a primary amine group, contributes also one active hydrogen equivalent. This is because after reaction with one isocyanate group, the second original hydrogen is no longer an active hydrogen. An active hydrogen-containing group, which is a carboxylic acid, contributes one active hydrogen equivalent for one carboxylic acid functionality.

The polyol reactant is a polyether polyol or a polyester polyol.

The polyether polyol is for example a polymer obtainable by polymerization of alkylene oxides or cyclic ethers with at least 4 ring atoms, which contains at least two active hydrogen-containing groups per molecule and at least two the contained active hydrogen-containing groups per molecule are hydroxyl groups. An active hydrogen-containing group is for example a primary hydroxyl group, a secondary hydroxyl group, a primary amine or a secondary amine. The in-tended function of the active hydrogen-containing group is the reaction with an isocyanate to form a covalent bond therewith. Preferably, the polyether polyol contains 2 to 8 active hydrogen-containing groups per molecule, very preferably 2 to 6, and most preferably 2 to 4 and especially preferably 2 to 3. A number of three active hydrogen-containing groups per molecule in the polyether polyol is also called a trifunctional polyether polyol. Alkylene oxides are for example ethylene oxide, propylene oxide, 1,2-butylene oxide, 2,3-butylene oxide or styrene oxide. Cyclic ethers are for example oxetane or tetrahydrofuran.

The polyether polyol is prepared for example by polymerizing alkylene oxides, alone or as a mixture or in succession, with initiator components containing at least two reactive hydrogen atoms. An initiator component containing at least two reactive hydrogen atoms is for example water, a polyalcohol, ammonia, a primary amine or a secondary amine containing a second reactive hydrogen atom. A polyalcohol is for example ethylene glycol, propane-1,2-diol, propane-1,3-diol, glycerine, trimethylolpropane, 4,4′-dihydroxydiphenylpropane or alphamethylglucoside.

A primary amine is for example ethanolamine, ethylene diamine, diethylenetriamine or aniline. A secondary amine containing a second reactive hydrogen atom is for example diethanolamine, triethanolamine or N-(2-hydroxyethyl)piperazine. The initiator component containing at least two reactive hydrogen atoms is preferably water or a polyalcohol. The initiator component containing at least two reactive hydrogen atoms contains preferably 2 to 6 reactive hydrogen atoms, more preferably 2 to 4 and most preferably 2 to 3. The average number of reactive hydrogen atoms in the initiator component used in preparing the polyether polyol defines a “nominal functionality” of the polyether polyol, i.e. the average number of active hydrogen-containing groups of the polyether polyol. The nominal functionality of the polyether polyol is preferably from 2 to 6, more preferably from 2 to 4, most preferably from 2 to 3.5 and especially preferably from 2 to 3.3.

The polyether polyol has for example a molecular weight of 400 to 10000 Dalton, preferably 800 to 10000 Dalton. The molecular weight is more preferably determined as the number average molecular weight (Mₙ or number average molar mass). Equivalent weight of the polyether polyol is defined herein as the molecular weight of the polyether polyol divided by its average number of active hydrogen-containing groups per molecule, preferably the number average molecular weight (Mₙ) is taken for determination of the equivalent weight. The equivalent weight of the polyether polyol, especially determined with the number average molecular weight (Mₙ), is preferably 400 to 5000, more preferably 800 to 2500, very preferably 900 to 1300 and especially preferably 1000 to 1200.

Preferred is a polyether polyol, which contains pre-dominantly (up to 90% by weight, based on all the hydroxyl groups present in the polyether polyol) active hydrogen-containing groups, which are secondary hydroxyl groups.

A polyester polyol is produced for example by polycondensation of a diacid and a diol, wherein the diol is applied in excess. Partial replacement of the diol by a polyol with more than two hydroxyl groups leads to a ramified polyester polyol. A diacid is for example adipic acid, glutaric acid, succinic acid, maleic acid or phthalic acid. A diol is for example ethylene glycol, diethylene glycol, 1,4-butane diol, 1,5-pentane diol, neopentyl glycol or 1,6-hexane diol. A polyol with more than two hydroxyl groups is for example glycerine, trimethylol propane or pentaerythritol.

A crosslinker is for example a further component of the reaction mixture. A crosslinker can improve the resiliency of the polyurethane foam. A crosslinker as defined herein possesses three 3 to 8, preferably 3 to 4 active hydrogen-containing groups per molecule. The crosslinker thus reacts with the polyisocyanate reactant and if present is considered as a reactant for calculation of the polyisocyanate index. The crosslinker is free of an ester bond and possesses an equivalent weight, especially determined with the number average molecular weight (Mₙ), of below 200. In case of the presence of a crosslinker, the polyether polyol possesses preferably an equivalent weight of the polyether polyol, especially determined with the number average molecular weight (Mₙ), of 400 to 5000. A crosslinker is for example an alkylene triol or an alkanolamine. An alkylene triol is for example glycerine or trimethylolpropane. An alkanolamine is for example diethanolamine, triisopropanolamine, triethanolamine, diisopropanolamine, an adduct of 4 to 8 moles of ethylene oxide with ethylene diamine or an adduct of 4 to 8 moles of propylene oxide with ethylene diamine. The crosslinker is preferably an alkanolamine, more preferably diethanolamine.

A chain extender is for example a further component of the reaction mixture. A chain extender as defined herein possesses two active hydrogen-containing groups per molecule, which are hydroxyl groups. The chain extender thus reacts with the polyisocyanate reactant and if present is considered as a reactant for calculation of the polyisocyanate index. The chain extender is free of an ester bond and possesses an equivalent weight, especially determined with the number average molecular weight (Mₙ), of between 31 and 300, preferably 31 to 150. In case of the presence of a chain extender, the polyether polyol possesses preferably an equivalent weight, especially determined with the number average molecular weight (Mₙ), of 400 to 5000. A chain extender is for example an alkylene glycol or a glycol ether. An alkylene glycol is for example ethylene glycol, 1,3-propylene glycol, 1,4-butylene glycol or 1,6-hexamethylene glycol. A glycol ether is for example diethylene glycol, triethylene glycol, dipropylene glycol, tripropylene glycol or 1,4-cyclohexanedimethanol.

If used, the combined amount of crosslinker and the chain extender in the reaction mixture is below 50 parts by weight based on 100 parts by weight of the polyol reactant. The combined amount is preferably below 20 parts by weight, more preferably below 5 parts by weight.

The reaction mixture prior to the reaction comprises a polyisocyanate reactant and a polyol reactant, and 60 to 100 parts by weight of the polyol reactant based on 100 parts by weight of the polyol reactant is preferably a polyether polyol. More preferably, 80 to 100 parts by weight of the polyol reactant is a polyether polyol, very preferably 95 to 100 parts by weight, most preferably 98 to 100 parts by weight and especially preferably, the polyol reactant is a polyether polyol.

The polyurethane foam is obtained from the reaction of the reaction mixture. The aforementioned preference can be expressed in an alternative form, i.e. the polyurethane foam is preferably obtained from the reaction of a polyisocyanate reactant and a polyol in a reaction mixture, and 60 to 100 parts by weight of the polyol reactant based on 100 parts by weight of the polyol reactant, which is a polyether polyol.

Preferred is a composition, wherein the polyurethane foam is obtained from the reaction of a polyisocyanate reactant and a polyol reactant in a reaction mixture.

Preferred is a composition, wherein the polyurethane foam is obtained from the reaction of a polyisocyanate reactant and a polyol reactant in a reaction mixture, wherein the reaction mixture comprises the polyisocyanate reactant, the polyol reactant and optionally water, a carboxylic acid or a blowing agent and optionally a surfactant and optionally a catalyst and optionally a crosslinker and optionally a chain extender.

Preferred is a composition, wherein the polyurethane foam is obtained from the reaction of a polyisocyanate reactant and a polyol reactant in a reaction mixture, and 60 to 100 parts by weight of the polyol reactant, based on 100 parts by weight of the polyol reactant, which is a polyether polyol.

Preferred is a composition, wherein the polyurethane foam is obtained from the reaction of a polyisocyanate reactant and a polyol reactant in a reaction mixture, and the reaction mixture contains prior to the reaction water, a carboxylic acid or a blowing agent.

Preferred is a composition, wherein component (i) is a polyurethane foam.

Preferred is a composition, wherein component (i) is a polyether polyol.

The content of the stabilizer combination (ii) in the composition is defined for a polyurethane foam as component (i) based on the polyol reactant in the reaction mixture, which reacts with the polyisocyanate reactant afterwards to form the polyurethane foam.

The content of the stabilizer combination (ii) in the composition is defined for a polyether polyol as component (i) based on the polyether polyol.

For both cases, the amount of the stabilizer combination (ii) is preferably from 0.01 to 10 parts by weight based on 100 parts by weight of the polyol reactant in case of a polyurethane foam or of the polyether polyol in case of a polyether polyol. More preferably, the amount is from 0.02 to 5 parts by weight, very preferably from 0.025 to 2.5 parts by weight and most preferably from 0.03 to 2 parts by weight.

It is an objective of the present invention to obtain a stabilizer combination and an improved stabilized composition for the synthetic polymer as described above compared to those known in the prior art.

Surprisingly it has been found that a stabilizer combination (ii) as defined above, preferably in liquid form, and preferably based on the following 3 components:
component (ii.1): at least one 3-phenyl-benzofuran-2-one derivative,
component (ii.2): at least one bisphenolic stabilizer and
component (ii.3): at least one aliphatic phosphite or phosphonate ester does show such improved effects.

The combination of stabilizers (ii) according to the present invention:

### (ii.1) The Benzofuranone Derivative

The benzofuranone derivate according to the present invention is a substituted 3-phenyl-benzo-furan-2-one derivative as of formula (I), preferably as defined herein below.

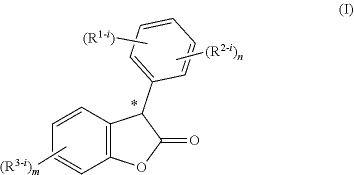

in which R¹⁻ⁱ is hydrogen, O-alkyl, O-acyl or O—P(OR^{a})(OR^{b});
R²⁻ⁱ and R³⁻ⁱ are independently from one another optionally substituted alkyl, cycloalkyl, alkenyl, phenylOR⁴, COOR⁵ or COR⁶,
   wherein
   R⁴, R⁵ and R⁶ are independently from one another hydrogen, alkyl, cycloalkyl, alkenyl, phenyl, which are optionally further substituted;
and
n and m are each an integer selected from 0, 1, 2, 3 or 4, or
   two residues R²⁻ⁱ or R³⁻ⁱ may each mean a fused carbo- or heterocyclic ring or the compounds of formula I are linked to a polymer chain via R¹⁻ⁱ, R²⁻ⁱ or R³⁻ⁱ, or R¹⁻ⁱ is O—P(OR^{a})(OR^{b}), wherein R^{a} and R^{b} may be an each an optionally alkyl-substituted aryl, which are linked to each other via CH₂ or a CHCH₃ group, and wherein the phosphoric atom may optionally be further oxidated to O—P(═O)(OR^{a})(OR^{b}).

Preferably R¹⁻ⁱ is O-acyl or O—P(OR^{a})(OR^{b}), wherein R^{a} and R^{b} may be an each an optionally with C₁-C₈-alkyl-substituted phenyl, which are linked to each other via CH₂ or a CHCH₃ group, and wherein the phosphoric atom may optionally be further oxidated to O—P(═O) (OR^{a})(OR^{b}) Preferably R²⁻ⁱ and R³⁻ⁱ are independently from one another selected from a linear or branched C₁-C₈-alkyl-

Preferably R²⁻ⁱ and R³⁻ⁱ are independently from one another selected from methyl, ethyl, n-propyl, iso-propyl, n-butyl, sec.-butyl, iso-butyl und tert.-butyl, wherein the alkyl radical may be further substituted with one or more C₁-C₄-alkyl radicals.

Preferably R²⁻ⁱ and R³⁻ⁱ are both the same and selected from methyl, ethyl, n-propyl, iso-propyl, n-butyl, sec.-butyl, iso-butyl und tert.-butyl, wherein the alkyl radical may be further substituted with one or more C₁-C₄-alkyl radicals.

Preferably n and m are independently from one another an integer selected 1 or 2.

Preferably in the benzofuranone compound of formula (I) R¹⁻ⁱ is O—P(OR^{a})(OR^{b}), wherein R^{a} and R^{b} are both a phenyl ring substituted with 2C(CH₃)₃ groups, which are linked to each other via CHCH₃ group, R²⁻ⁱ is methyl and R³⁻ⁱ is C(CH₃)₃ and m and n are respectively 2. Optionally the phosphoric atom may optionally be further oxidated to O—P(═O) (OR^{a})(OR^{b}).

Preferably in the benzofuranone compound of formula (I) R¹⁻ⁱ is hydrogen or O-acyl and R²⁻ⁱ is identical to R³⁻ⁱ and m is identical to n.

Preferably in the benzofuranone compound of formula (I) R¹⁻ⁱ is acetoxy and R²⁻ⁱ and R³⁻ⁱ are both C(CH₃)₂CH₂C(CH₃)₃ and m and n are both 1.

Preferably in the benzofuranone compound of formula (I) R¹⁻ⁱ is 2-oxo-ethyl 6-hydroxyhexanoate derivative with three repeating 6-hydroxyhexanoate units and R²⁻ⁱ is hydrogen, R³⁻ⁱ is C(CH₃)₂ and m is 2.

Preferably in the benzofuranone compound of formula (I) R¹⁻ⁱ is p-salicylic ester substituted with 2 groups of C(CH₃)₃ and R²⁻ⁱ are both C(CH₃)₃ and m and n are both 1.

The benzofuranone compound of formula I possess at least one asymmetric *carbon atom, i.e. a carbon atom at the 3-position of the benzofuran-2-one structural unit. A further asymmetric carbon atom is present in case R¹⁻ⁱ is O—P(OR^{a})(OR^{b}), and the linking group between (OR^{a})(OR^{b}) is CHCH₃.

### (ii.2) The Sterically Hindered Phenol Compound

The sterically hindered phenol compound according to the present invention is a phenolic stabilizer, preferably a bisphenolic stabilizer compound according to formula (II)

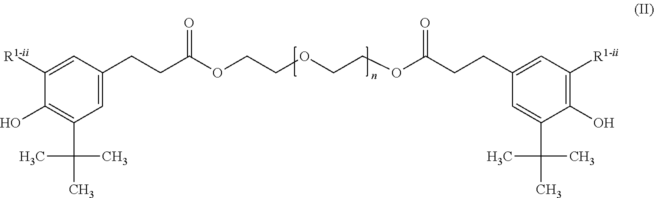

Wherein
R¹⁻ⁱⁱ are both independently from one another methyl or tert-butyl;
n is 1, 2, 3, 4, 5, 6, 7, 8, 9, 10 or 11;

Preferably in formula (II) of the bisphenolic stabilizer n is 1, 2, 3, 4, 5 or 6.

Especially preferred is a bisphenolic stabilizer of formula II with n=1, 2, 3 or 4, in particular with n=2, 3 or 4 and very particular with n=2 or 3.

### (ii.3) the Aliphatic Phosphorous (III) Compound

The aliphatic phosphorous (III) compounds according to the present invention may be either present either as phosphite ester compounds or in the phosphonate ester form. Phosphites are compounds of the P(OR^{c})(OR^{d}) (OR^{e}) type with R^{c}, R^{d}, R^{e} as identical or different aliphatic radicals, and phosphonates are compounds of the R^{f}—PO(OR^{c})(OR^{d}) type with R^{f}, R^{c} and R^{d} as identical or different aliphatic radicals. Preferably R^{c}; R^{d} and R^{e} may be each independently from one another an alkyl-substituted C₁ to C₂₀-alky, whereas R^{f} may be hydrogen or an alkyl-substituted C₁ to C₂₀-alky.

The phosphite or phosphonate ester compound according to the present invention is of aliphatic origin, which means it is an ester of an aliphatic alcohol having at least one primary hydroxyl group (i.e. HO—CH₂— . . . ).

Preferably the aliphatic phosphorous (III) compounds according to the present invention is in form of a phosphonate diester compound Rf—PO(OR^{c})(OR^{d}), wherein Rf is hydrogen.

More preferably the aliphatic phosphorous (III) compounds according to the present invention is in form of a phosphonate diester compound, Rf—PO(OR^{c})(OR^{d}), wherein R^{f} is hydrogen and R^{c}; and R^{d} are both the same alkyl-substituted C₁ to C₂₀-alky

An especially preferred the aliphatic phosphorous (III) compounds for use according to the present invention is H—P(═O) (OC₈H₁₇) (OC₈H₁₇).

### Preferences

The individual embodiments and preferences of the stabilizer combination according to the present invention are outlined in the paragraphs below:

For component (ii.1), the 3-phenyl-benzofuran-2-one derivative: Stabilizer component (I.1-1) is depicted below and obtainable according to example S-8 of WO 2015/121445 A1.

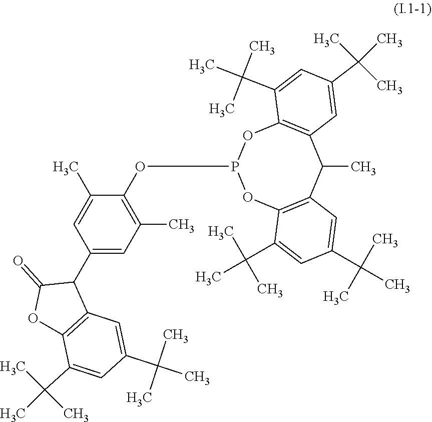 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)C(C)c2cc(C(C)(C)C)cc(C(C)(C)C)c2O1]

Stabilizer component (I.1-2) is depicted below and obtainable according to example P-2 of WO 2017/025431 A1.

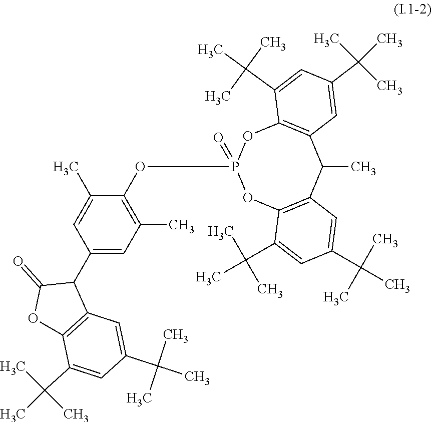 [SMILES: Cc1cc(C2C(=O)Oc3c2cc(C(C)(C)C)cc3C(C)(C)C)cc(C)c1OP1(=O)Oc2c(cc(C(C)(C)C)cc2C(C)(C)C)C(C)c2cc(C(C)(C)C)cc(C(C)(C)C)c2O1]

Stabilizer component (I.1-3) is depicted below and obtainable according to EP 0871066 A1 with its compound No. I-30.

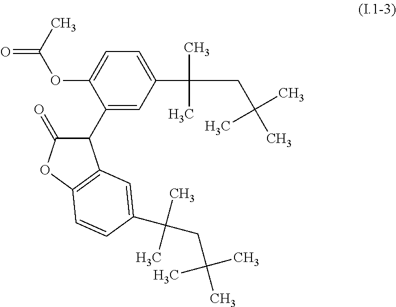 [SMILES: CC(=O)Oc1ccc(C(C)(C)CC(C)(C)C)cc1C1C(=O)Oc2ccc(C(C)(C)CC(C)(C)C)cc21]

Stabilizer component (I.1-4) is the product of a reaction of 5,7-ditert-butyl-3-[4-(2-hydroxyeth-oxy)phenyl]-3H-benzofuran-2-one and of ε-caprolactone and is depicted below and is obtainable according to example 3 of WO 2006/065829 A1.

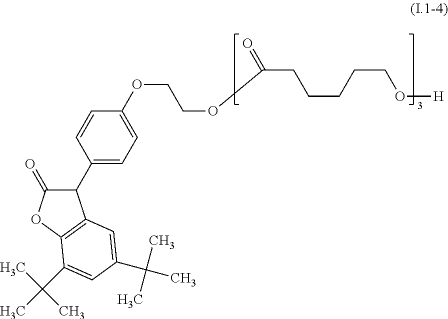

Stabilizer component (I.1-5), which is 4-tert-butyl-2-(5-tert-butyl-2-oxo-2,3-dihydro-1-benzofuran-3-yl)phenyl 3,5-di-tert-butyl-4-hydroxybenzoate and depicted below, is a commercially available as Revonox 501™

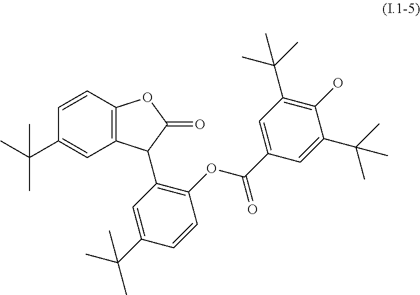 [SMILES: CC(C)(C)c1ccc(OC(=O)c2cc(C(C)(C)C)c(O)c(C(C)(C)C)c2)c(C2C(=O)Oc3ccc(C(C)(C)C)cc32)c1]

For component (ii.2), the bisphenolic stabilizer:

Stabilizer component (II.2-1) is the product of a transesterification of 3-(3,5-di-tert-butyl-4-hydroxyphenyl)-propionic acid methyl ester with polyethylene glycol 200s depicted below and is obtainable according to example 1a of WO 2010/003813 A1

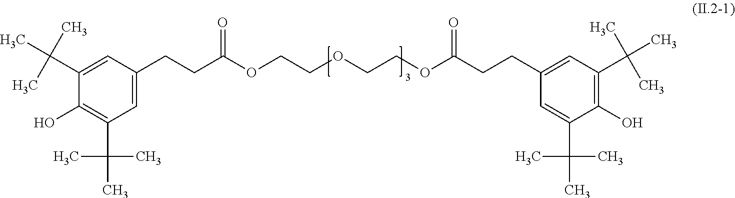

Stabilizer component (II.2-2) is depicted below and is commercially obtainable as Irganox 245™.

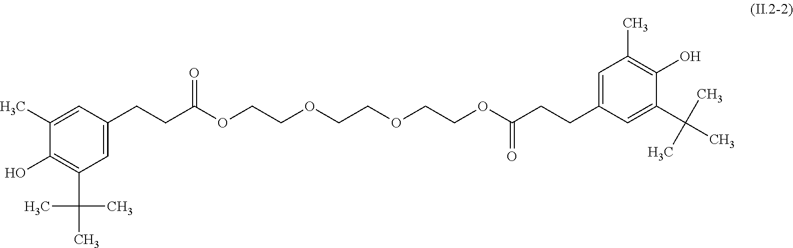 [SMILES: Cc1cc(CCC(=O)OCCOCCOCCOC(=O)CCc2cc(C)c(O)c(C(C)(C)C)c2)cc(C(C)(C)C)c1O]

For component (ii.3), the aliphatic phosphorous (III) compound:

Preferred aliphatic phosphite or phosphonate esters compounds to be used for the purpose of the present invention are for example Bis(2-ethylhexyl) hydrogen phosphite, Dimethyl hydrogen phosphite, Dioleyl hydrogen phosphite, Dibutyl hydrogen phosphite, Di-n-octyl hydrogen phosphite, Dilauryl hydrogen phosphite, Tri alkyl (C12-C15) phosphite [CAS No. 68610-62-8], Tri-C12-C14-phosphite [CAS No. 93686-48-7], Tris(tridecyl)phosphite, Triisodecyl phosphite, Triisotridecyl phosphite, Tris (Dipropyleneglycol) Phosphite, Trioctyl Phosphite, Tridecyl phosphite·trilauryl phosphite, Trilauryl Trithio Phosphite, trioctadecyl phosphite, Triisooctyl Phosphite, Diisodecyl pentaerythritol diphosphate, heptakis (dipropyleneglycol) Triphosphite and (Dipropyleneglycol) Phosphite.

The aliphatic phosphorous (III) compounds preferably used for the present invention are liquid dialkyl hydrogen phosphites and trialkyl phosphites.

More preferred are liquid di-alkyl hydrogen phosphites.

Examples for such di-alkyl hydrogen phosphites are Dioleyl hydrogen phosphite and di-octyl hydrogen phosphite.

Especially preferred is di-octyl hydrogen phosphite.

The composition according to the present invention may preferably comprise further components as additives.

These further additives may for example be selected from the following list:

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethyl-phenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylhepta-dec-1′-yl)phenol, 2,4-dimethyl-6-(1′-methyltridec-1′-yl)phenol, 2,4-dimethyl-6-(1′-methyl-1′-tetra-decyl-methyl)-phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecyl-thiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyl-oxy-phenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E), vitamin E acetate.

Especially preferred is the addition of 2,5,7,8-tetramethyl-2-[4,8,12-trimethyltridecyl]-chroman-6-ol] as depicted below.

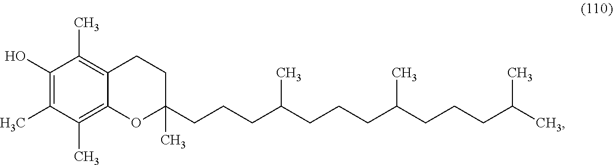 [SMILES: Cc1c(C)c2c(c(C)c1O)CCC(C)(CCCC(C)CCCC(C)CCCC(C)C)O2]

which is a commercially available vitamin E (e.g. Irganox E 201™).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxy-phenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, iso-octyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetra-methylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, (3,5-ditert-butyl-4-hydroxy-phenyl)methylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, for example with methanol, ethanol, n-octanol, i-octanol, a mixture of linear and branched C₇-C₉-alkanol, octadecanol, a mixture of linear and branched C₃-C₁₅-alkanol, 1,6-hexanediol, 1,9-nonanediol, ethylene glycol, 1,2-propanediol, neopentyl glycol, thiodiethylene glycol, diethylene glycol, triethylene glycol, tetraethylene glycol, pentaerythritol, tris(hydroxyethyl)isocyanurate, N,N′-bis-(hydroxy-ethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane. Preferred are esters of β-(3,5-di-tert-butyl-4-hydroxyphenyl)propionic acid, especially with octadecanol, such as the addition of Octadecyl-3-(3,5-di-tert.butyl-4-hydroxyphenyl)-propionate as depicted in formula (V) below.

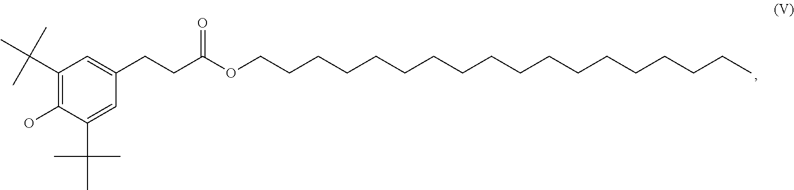 [SMILES: CCCCCCCCCCCCCCCCCCOC(=O)CCc1cc(C(C)(C)C)c(O)c(C(C)(C)C)c1]

which is a commercially available (e.g. Irganox 1076™).

1.14. Esters of β-(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxy-ethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of β-(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, eth-ylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid, for example N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard XL-1 (RTM), supplied by SI Group).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclo-hexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldi-phenylamines, a mixture of mono- and dialkylated dodecyldiphenylamines, a mixture of mono- and dialkylated isopropyl/isohexyldiphenylamines, a mixture of mono- and dialkylated tert-butyl-diphenylamines, 2,3-dihydro-3,3-dimethyl-4H-1,4-benzothiazine, phenothiazine, a mixture of mono- and dialkylated tert-butyl/tert-octylphenothiazines or a mixture of mono- and dialkylated tert-octylphenothiazines, N-allylphenothiazine, N,N,N′,N′-tetraphenyl-1,4-diaminobut-2-ene, N-[(1,1,3,3-tetramethylbutyl)phenyl]-1-napthalenamine] (commercially available as Irganox L06™)

2. UV absorbers and light stabilisers

2.1.2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbon-ylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbon-ylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

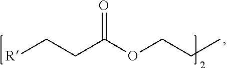

where R′=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.

2.2.2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate, N-(β-carbomethoxy-β-cyanovinyl)-2-methylindoline and neopentyl tetra(α-cyano-β,β-diphenylacrylate).

2.5. Nickel compounds, for example nickel complexes of 2,2′-thiobis[4-(1,1,3,3-tetramethyl-butyl)phenol], such as the 1:1 or 1:2 complex, with or without additional ligands such as n-butyl-amine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzyl-phosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperid-4-yl)sebacate, bis(1-octyloxy-2,2,6,6-tetramethylpiperid-4-yl)succinate, bis-[2,2,6,6-tetramethyl-1-(undecyloxy)-piperidin-4-yl] carbonate, linear or cyclic condensates of N,N′-bis(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropyl-amino)ethane, 8-acetyl-3-dodecyl-7,7,9,9-tetramethyl-1,3,8-triazaspiro[4.5]-decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperid-yl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268 64-7]); reaction products of N6,N6′-hexane-1,6-diylbis[N2,N4-dibutyl-N2,N4,N6-tris(2,2,6,6-tetramethylpiperidin-4-yl)-1,3,5-triazine-2,4,6-tri-amine], butanal and hydrogen peroxide; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pen-tamethyl-4-piperidyloxycarbonyl)-2-(4-methoxyphenyl)-ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxy-piperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, a mixture of oligomeric compounds which are the formal condensation products of N,N′-bis-(2,2,6,6-tetramethyl-1-propoxy-piperidin-4-yl)-hexane-1,6-diamine and 2,4-dichloro-6-{n-butyl-(2,2,6,6-tetramethyl-1-propoxy-piperidin-4-yl)-amino}-[1,3,5]triazine end-capped with 2-chloro-4,6-bis-(di-n-butylamino)-[1,3,5]triazine, a mixture of oligomeric compounds which are the formal condensation products of N,N′-bis-(2,2,6,6-tetramethyl-piperidin-4-yl)-hexane-1,6-diamine and 2,4-dichloro-6-{n-butyl-(2,2,6,6-tetramethyl-piperidin-4-yl)-amino}-[1,3,5]triazine end-capped with 2-chloro-4,6-bis-(di-n-butylamino)-[1,3,5]triazine, (N2,N4-dibutyl-N2,N4-bis(1,2,2,6,6-pentamethyl-4-piperidinyl)-6-(1-pyrrolidinyl)-[1,3,5]-triazine-2,4-diamine, 2,4-bis[N-(1-cyclohexyloxy-2,2,6,6-tetra-methylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. [106917-31-1]), 5-(2-ethylhexanoyl)-oxymethyl-3,3,5-trimethyl-2-morpholinone, the reaction product of 2,4-bis-[(1-cyclo-hexyloxy-2,2,6,6-piperidine-4-yl)butylamino]-6-chloro-s-triazine with N,N′-bis-(3-amino-propyl)ethylenediamine), 1,3,5-tris(N-cyclohexyl-N-(2,2,6,6-tetramethyl-piperazine-3-one-4-yl)amino)-s-triazine, 1,3,5-tris(N-cyclohexyl-N-(1,2,2,6,6-pentamethylpiperazine-3-one-4-yl)-amino)-s-triazine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8.2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxy-phenyl)-6-(2,4-dimethylphenyl)-1,3,5-triazine, 2-(2-hydroxy-4-octyloxyphenyl)-4,6-bis(4-methyl-phenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tri-decyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonates are required additives of the stabilizer combination according to the present invention. Already mentioned have been for instance Tris alkyl (C12-C15) phosphite, Triisodecyl phosphite, Triisotridecyl phosphite, Dioleyl Hydrogen phosphite, Triisooctyl Phosphite, Heptakis (dipropyleneglycol) Triphosphite, Trilauryl Trithio Phosphite, Tris (Dipropyleneglycol) Phosphite, Dimethyl hydrogen phosphite, Dibutyl hydrogen phosphite, Dilauryl hydrogen phosphite, Tri-C12-C14-phosphite, Bis(2-ethylhexyl) hydrogen phosphite and—especially preferred—liquid phosphites such as Di-n-octyl hydrogen phosphite or Di-iso-octyl hydrogen phosphite.

However, further phosphites and phosphonates, which are different to those defined components (ii.3), but which can be used additionally in the compositions according to the present invention are preferably liquid ones as for example triphenyl phosphite, tris(nonylphenyl) phosphite, Phenyldiisodecyl phosphite, Diphenylisodecyl phosphite, [Triphenyl phosphite, polymer with 1,4-cyclohexanedimethanol and polypropylene glycol, C10-16 alkyl esters (CAS Reg. No. 1821217-71-3)].

Further optional phosphites or phosphonates additives to be mentioned here as well are for instance Alkyl (C12-C15) bisphenol A phosphite, Alkyl (C10) bisphenol A phosphite, Poly (dipropyleneglycol) phenyl phosphite, Tris (tridecyl) phosphite, Diphenyl phosphite, Dodecyl nonylphenol phosphite blend, Phenyl Neopentylene Glycol Phosphite, Poly 4,4′ Isopropy-lidenediphenol-C10 Alcohol Phosphite, Poly 4,4′ Isopropylidenediphenol-C₁₂₋₁₅ Alcohol Phosphite, diphenylalkyl phosphites, phenyldialkyl phosphites, C12-C18 alkyl bis[4-(1-methyl-1-phenyl-ethyl)phenyl] phosphite, C₁₂-C₁₈ alkenyl bis[4-(1-methyl-1-phenyl-ethyl)phenyl] phosphite, bis[4-(1-methyl-1-phenyl-ethyl)phenyl] [(E)-octadec-9-enyl] phosphite, decyl bis[4-(1-methyl-1-phenyl-ethyl)phenyl] phosphite, didecyl [4-(1-methyl-1-phenyl-ethyl)phenyl] phosphite, [4-(1-methyl-1-phenyl-ethyl)phenyl] bis[(E)-octadec-9-enyl] phosphite, trilauryl phosphite, trioctadecyl phosphite, distearylpentaerythritol diphosphite, tris(2,4-di-tert-butylphenyl) phosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentae-rythritol diphosphite, bis(2,4-di-tert-butyl-6-methylphenyl)pentaerythritol diphosphite, bis(2,4,6-tris(tert-butylphenyl)pentaerythritol diphosphite, [2-tert-butyl-4-[1-[5-tert-butyl-4-di(tridecoxy)phosphanyloxy-2-methyl-phenyl]butyl]-5-methyl-phenyl] ditridecyl phosphite, a mixture of at least two different tris(mono-C₁-C₈-alkyl)phenyl phosphites such as for example mentioned in U.S. Pat. No. 7,468,410 B2 as products of examples 1 and 2, a mixture of phosphites comprising at least two different tris(amylphenyl) phosphites such as for example mentioned in U.S. Pat. No. 8,008,383 B2 as mixtures 14, 15, 16, 17, 18, 19, 20, 21, 22, 23, 24, 25 and 26, a mixture of a least four different phosphites comprising tris[4-(1,1-dimethylpropyl)phenyl] phosphite, [2,4-bis(1,1-dimethylpropyl)phenyl] bis[4-(1,1-dimethylpropyl)phenyl] phosphite, bis[2,4-bis(1,1-dimethylpro-pyl)phenyl] [4-(1,1-dimethylpropyl)phenyl] phosphite and tris[2,4-bis(1,1-dimethylpropyl)phenyl]phosphite, a mixture of phosphites comprising at least two different tris(butylphenyl) phosphites such as for example mentioned in U.S. Pat. No. 8,008,383 B2 as mixtures 34, 35, 36, 37, 38, 39 and 40, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocine, 1,3,7,9-tetra-tert-butyl-11-octoxy-5H-benzo[d][1,3,2]benzodioxaphosphocine, 2,2′,2″-nitrilo[tri-ethyltris(3,3′,5,5′-tetra-tert-butyl-1,1′-biphenyl-2,2′-diyl)phosphite], phosphorous acid, triphenyl ester, polymer with α-hydro-ω-hydroxypoly[oxy(methyl-1,2-ethanediyl)], C₁₀₋₁₆-alkyl esters (CAS Reg. No. [1227937-46-3]), 2-ethylhexyl(3,3′,5,5′-tetra-tert-butyl-1,1′-biphenyl-2,2′-diyl)phosphite, mixed 2,4-bis(1,1-dimethylpropyl)phenyl and 4-(1,1-dimethylpropyl)phenyl tri-esters (CAS Reg. No. [939402-02-5]).

5. Hydroxylamines and amine N-oxides, for example N,N-dibenzylhydroxylamine, N,N-diethylhy-droxylamine, N,N-dioctylhydroxylamine, N,N-dilaurylhydroxylamine, N,N-ditetradecylhydroxyla-mine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine, N,N-bis-(hydrogenated rape-oil alkyl)-N-methyl-amine N-oxide or trialkylamine N-oxide.

6. Nitrones, for example N-benzyl-alpha-phenylnitrone, N-ethyl-alpha-methylnitrone, N-octyl-al-pha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, distearyl thiodipropionate and pentaerythritol tetrakis-[3-(n-lauryl)-propionic acid ester].

8. Peroxide scavengers, for example esters of α-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Acid scavengers, for example melamine, polyvinylpyrrolidone, dicyandiamide, triallyl cyanurate, urea derivatives, hydrazine derivatives, alkali metal salts and alkaline earth metal salts of higher fatty acids, for example calcium stearate, zinc stearate, magnesium behenate, magnesium stearate, sodium ricinoleate and potassium palmitate, antimony pyrocatecholate and zinc pyrocatecholate.

10. Further Benzofuranones, which are different to those defined above, and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839 or EP-A-0591102, or 5,7-di-tert-butyl-3-(4-hydroxyphenyl)-3H-benzofuran-2-one, 5,7-di-tert-butyl-3-[4-(2-hydroxyethoxy)phenyl]-3H-benzofuran-2-one, 5,7-di-tert-butyl-3-[4-[2-[2-[2-[2-(2-hydroxy-ethoxy)ethoxy]ethoxy]ethoxy]ethoxy]phenyl]-3H-benzofuran-2-one, 3-[4-(2-acetoxyethoxy)phenyl]-5,7-di-tert-butylbenzofuran-2-one, 5,7-di-tert-butyl-3-[4-(2-stearoyloxyethoxy)phenyl]benzo-furan-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-bu-tylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-bu-tylbenzofuran-2-one, 3-(2-acetoxy-4-(1,1,3,3-tetramethyl-butyl)-phenyl)-5-(1,1,3,3-tetramethyl-butyl)-benzofuran-2-one, [6-[6-[6-[2-[4-(5,7-di-tert-butyl-2-oxo-3H-benzofuran-3-yl)phenoxy]ethoxy]-6-oxo-hexoxy]-6-oxo-hexoxy]-6-oxo-hexyl] 6-hydroxyhexanoate, [4-tert-butyl-2-(5-tert-butyl-2-oxo-3H-benzofuran-3-yl)phenyl] benzoate, [4-tert-butyl-2-(5-tert-butyl-2-oxo-3H-benzofuran-3-yl)phenyl] 3,5-di-tert-butyl-4-hydroxy-benzoate and [4-tert-butyl-2-(5-tert-butyl-2-oxo-3H-benzo-furan-3-yl)phenyl] 3-(3,5-di-tert-butyl-4-hydroxy-phenyl)propanoate.

11. Flame retardants

11.1. Phosphorus containing flame retardants including reactive phosphorous containing flame retardants, for example tetraphenyl resorcinol diphosphite (Fyrolflex RDP, RTM, Akzo Nobel), tetrakis(hydroxymethyl)phosphonium sulphide, triphenyl phosphate, diethyl-N,N-bis(2-hydroxy-ethyl)-aminomethyl phosphonate, hydroxyalkyl esters of phosphorus acids, alkylphosphate oligomers, ammonium polyphosphate (APP), resorcinol diphosphate oligomer (RDP), phosphazene flame retardants or ethylenediamine diphosphate (EDAP).

11.2. Nitrogen containing flame retardants, for example melamine-based flame retardants, iso-cyanurates, polyisocyanurate, esters of isocyanuric acid, like tris-(2-hydroxyethyl)isocyanurate, tris(hydroxymethyl)isocyanurate, tris(3-hydroxy-n-propyl)isocyanurate, triglycidyl isocyanurate, melamine cyanurate, melamine borate, melamine phosphate, melamine pyrophosphate, melamine polyphosphate, melamine ammonium polyphosphate, melamine ammonium pyrophosphate, dimelamine phosphate, dimelamine pyrophosphate, benzoguanamine, allantoin, glyco-luril, urea cyanurate, a condensation product of melamine from the series melem, melam, melon and/or a higher condensed compound or a reaction product of melamine with phosphoric acid or a mixture thereof.

11.3. Organohalogen flame retardants, for example polybrominated diphenyl oxide, decabromo-diphenyl oxide (DBDPO), tris[3-bromo-2,2-bis(bromomethyl)propyl] phosphate (PB 370, (RTM, FMC Corp.)), tris(2,3-dibromopropyl)phosphate, chloroalkyl phosphate esters such as tris(chloropropyl)phosphate, tris(2,3-dichloropropyl)phosphate, tris(1,3-dichloro-2-propyl)phosphate (Fyrol FR 2 (RTM ICL)), oligomeric chloroalkyl phosphate, chlorendic acid, tetrachlorophthalic acid, tetrabromophthalic acid, poly-β-chloroethyl triphosphonate mixture, tetrabromobisphenol A-bis(2,3-dibromopropyl ether) (PE68), brominated epoxy resin, brominated aryl esters, eth-ylene-bis(tetrabromophthalimide) (Saytex BT-93 (RTM, Albemarle)), bis(hexachlorocyclopenta-dieno)cyclooctane (Declorane Plus (RTM, Oxychem)), chlorinated paraffins, octabromodiphenyl ether, hexachlorocyclopentadiene derivatives, 1,2-bis(tribromophenoxy)ethane (FF680), tetrabromobisphenol A (Saytex RB100 (RTM, Albemarle)), ethylene bis-(dibromonorbornanedicar-boximide) (Saytex BN-451 (RTM, Albemarle)), bis-(hexachlorocycloentadeno)cyclooctane, PTFE, tris (2,3-dibromopropyl) isocyanurate or ethylene-bis-tetrabromophthalimide.

Some of the halogenated flame retardants mentioned above are routinely combined with an inorganic oxide synergist. Some of the halogentated flame retardants mentioned above can be used in combination with triaryl phosphates (such as the propylated, butylated triphenyl phosphates) and the like and/or with oligomeric aryl phosphates (such as resorcinol bis(diphenyl phosphate), bisphenol A bis(diphenyl phosphate), neopentylglycol bis(diphenyl phosphate)) and the like.

11.4. Inorganic flame retardants, for example aluminium trihydroxide (ATH), boehmite (AlOOH), magnesium dihydroxide (MDH), zinc borates, CaCO₃, organically modified layered silicates, organically modified layered double hydroxides, and mixtures thereof. In regard to the synergistic combination with halogenated flame retardants, the most common inorganic oxide synergists are zinc oxides, antimony oxides like Sb₂O₃ or Sb₂O₅ or boron compounds.

From these further additives listed above, some compounds are preferably present as well in the compositions according to the present invention.

Preferably the composition according to the present invention may comprise
(iii) at least one further additive selected
   from the group of chromanol antioxidants such as—α-tocopherol, β-tocopherol, γ-tocopherol, δ-tocopherol and mixtures thereof (vitamin E), vitamin E acetate; and/or from the group of aromatic aminic antioxidants such as a phenylarylamine, wherein the amine is only substituted with a phenyl and an C₆-C₁₀-aryl and the phenyl or the C₆-C₁₀-aryl is alkylated;
   and/or
   from the group of esters of 3,5-di-tert-butyl-4-hydroxyphenyl acetic acid with mono- or polyhydric alcohols, such as methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

Especially preferred the composition according to the present invention comprises as further additive (iii) at least one chromanol stabilizer of formula III

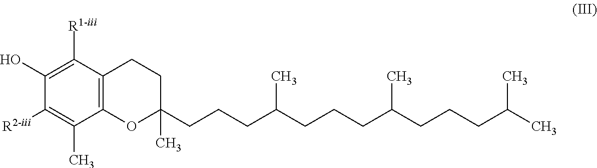

wherein R¹⁻ⁱⁱⁱ and R²⁻ⁱⁱⁱ are independently of each other H or methyl.

Alternatively, or in addition a commercially available technical mixtures of additives may be added as well, of which especially preferred is Irganox 5057™, which is obtained by the reaction of diphenylamine with diisobutylene, and which comprises
(A)₅₀₅₇ diphenylamine;
(B)₅₀₅₇ 4-tert-butyldiphenylamine;
(C)₅₀₅₇ compounds of the group
   i) 4-tert-octyldiphenylamine,
   ii) 4,4′-di-tert-butyldiphenylamine,
   iii) 2,4,4′-tris-tert-butyldiphenylamine,
(D)₅₀₅₇ compounds of the group
   i) 4-tert-butyl-4′-tert-octyldiphenylamine,
   ii) o,o′, m,m′, or p,p′-di-tert-octyldiphenylamine,
   iii) 2,4-di-tert-butyl-4′-tert-octyldiphenylamine,
(E)₅₀₅₇ compounds of the group
   i) 4,4′-di-tert-octyldiphenylamine,
   ii) 2,4-di-tert-octyl-4′-tert-butyldiphenylamine, and
      wherein not more than 5% by weight of component (A)₅₀₅₇, 8 to 15% by weight of component (B)₅₀₅₇, 24 to 32% by weight of component (C)₅₀₅₇, 23 to 34% by weight of component (D)₅₀₅₇ and 21 to 34% by weight of component (E)₅₀₅₇ are present. It is commercially available.

Furthermore, in addition to the bisphenolic stabilizer, a further phenolic antioxidant may optionally be present in the compositions according to the present invention.

Especially preferred is for instance an ester of β-(3,5-di-tert-butyl-4-hydroxyphenyl)propionic acid with octadecanol.

Such octadecyl-3-(3,5-di-tert.butyl-4-hydroxyphenyl)-propionate depicted in formula (V) below

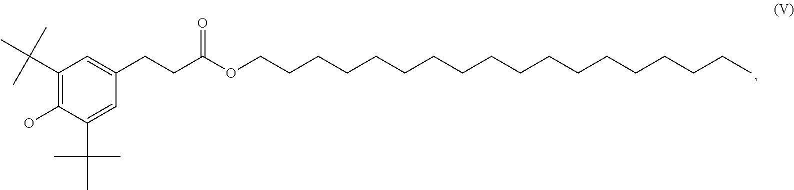 [SMILES: CCCCCCCCCCCCCCCCCCOC(=O)CCc1cc(C(C)(C)C)c(O)c(C(C)(C)C)c1]

is a commercially available as Irganox 1076™.

The addition of octadecyl-3-(3,5-di-tert.butyl-4-hydroxyphenyl)-propionate may also provide the possibility to lower the content of the bisphenolic stabilizer present. In such cases the concentration of the phenolic antioxidant will have to be added to the concentration of component (ii.2), the sterically hindered phenol, preferably the bisphenolic stabilizer, in order to achieve the desired ratios of component (ii.1):(ii.2):(ii.3).

As discussed above, the present invention demonstrates that a ternary stabilizer combination (ii), based on the three components:
component (ii.1), the 3-phenyl-benzofuran-2-one derivative,
component (ii.2), the bisphenolic stabilizer, and
component (ii.3), the aliphatic phosphite ester, does show improved stabilizing effects.

However, according to the present invention, further additives may optionally be present as well.

Hence, a preferred stabilizer composition according to the present invention comprises the stabilizers combination in the following weight percentages
(ii.1) 5-50% by weight of a 3-Phenyl-benzofuran-2-one derivative as defined herein above,
(ii.2) 5-90% by weight of a bisphenolic stabilizer of formula II defined herein above and
(ii.3) 5-50% by weight of an aliphatic phosphite ester as defined herein above; and optionally (iii.1) 0-30% by weight of a first further additive, and optionally
(iii.2) 0-30% by weight of a second further additive.

An especially preferred stabilizer composition comprises the combined stabilizers in the following weight percentages:
(ii.1) 5-20% by weight of a 3-Phenyl-benzofuran-2-one derivative as defined herein above,
(ii.2) 60-80% by weight of a bisphenolic stabilizer of formula II defined herein above and
(ii.3) 5-20% by weight of an aliphatic phosphite ester as defined herein above; and optionally
(iii.1) 0-15% by weight of a first further additive, and optionally
(iii.2) 0-15% by weight of a second further additive.

As first further additive, for instance, 2,5,7,8-tetramethyl-2-[4,8,12-trimethyltridecyl]chroman-6-ol] (also known as vitamin E, e.g. commercially available as Irganox E 201™) may be present.

As second further additive, for instance, a technical mixture of aromatic amines, obtained by the reaction of diphenylamine with diisobutylene (also commercially available as Irganox 5057™) may be present.

As third further additive, for instance, octadecyl-3-(3,5-di-tert.butyl-4-hydroxyphenyl)-propionate (commercially available as Irganox 1076™) may be present.

The expression “first”, “second” and “third” additive does not imply any priority or sequence of addition of the respective additive.

For instance, the “third” named further additive octadecyl-3-(3,5-di-tert.butyl-4-hydroxyphenyl)-propionate may be added to inventive ternary stabilizer combination without another further additive being present.

Taking into account the above preferred combinations, the weight ratio between component (ii.1), component (ii.2) and component (ii.3) is preferably 1:2:1 to 1:20:1.

A further embodiment of the present invention is represented by the weight ratio of the components (ii.1) and (ii.2) from 1:3 to 3:1.

More preferably the weight ratio between component (ii.1), component (ii.2) and component (ii.3) is from 1:4:1 to 1:10:1.

A further embodiment of the present invention is represented by the weight ratio of the components (ii.1) and (ii.2) is preferably from 1:2 to 2:1.

If further additives, as mentioned herein above, are present in the composition according to the present inventions the weight ratio between component (ii)—meaning the overall weight of [(ii.1)+(ii.2)+(ii.3)]—and the further component (iii)—meaning the overall weight of the further additives [(ii.1)+(iii.2) . . . ] is from (50-100) vs (0-20).

Preferably the overall weight of the stabilizer combination (ii) vs the overall weight of the further additive(s) (iii) is (60-95): (2-15).

Preferred is a composition, which comprises
(i) a polyurethane foam or a polyether polyol,
(ii) a ternary stabilizer combination of a 3-Phenyl-benzofuran-2-one derivative, a bisphenolic stabilizer and an aliphatic phosphite ester as defined above
(iii) preferably a first further additive, which is 2,5,7,8-tetramethyl-2-[4,8,12-trimethyl-tridecyl]chroman-6-ol] (also known as vitamin E, e.g. commercially available as Irganox E 201™).

Preferred is a composition, which comprises
(i) a polyurethane foam or a polyether polyol,
(ii) a ternary stabilizer combination of a 3-Phenyl-benzofuran-2-one derivative, a bisphenolic stabilizer and an aliphatic phosphite ester as defined above,
(iii) preferably a first further additive, which is a technical mixture of aromatic amines obtained by the reaction of diphenylamine with diisobutylene (also commercially available as Irganox 5057™).

Preferred is a composition, which comprises
(i) a polyurethane foam or a polyether polyol,
(ii) a ternary stabilizer combination of a 3-Phenyl-benzofuran-2-one derivative, a bisphenolic stabilizer and an aliphatic phosphite ester as defined above
(iii) preferably a first further additive, which is octadecyl-3-(3,5-di-tert.butyl-4-hydroxy-phenyl)-propionate] (commercially available as Irganox 1076™).

Preferred is a composition, which comprises
(i) a polyurethane foam or a polyether polyol,
(ii) a ternary stabilizer combination of a 3-Phenyl-benzofuran-2-one derivative, a bisphenolic stabilizer and an aliphatic phosphite ester as defined above,
(iii.1) preferably a first further additive, which is 2,5,7,8-tetramethyl-2-[4,8,12-trimethyltridecyl]chroman-6-ol] (also known as vitamin E, e.g. commercially available as Irganox E 201™)
(iii.2) preferably a second further additive, which is a technical mixture of aromatic amines obtained by the reaction of diphenylamine with diisobutylene (also commercially available as Irganox 5057™).

Preferred is a composition, which comprises
(i) a polyurethane foam or a polyether polyol,
(ii) a ternary stabilizer combination of a 3-Phenyl-benzofuran-2-one derivative, a bisphenolic stabilizer and an aliphatic phosphite ester as defined above,
(iii.1) preferably a first further additive, which is 2,5,7,8-tetramethyl-2-[4,8,12-trimethyl-tridecyl]chroman-6-ol] (also known as vitamin E, e.g. commercially available as Irganox E 201™)
(iii.2) preferably a second further additive, which is octadecyl-3-(3,5-di-tert.butyl-4-hydroxyphenyl)-propionate] (commercially available as Irganox 1076™)

Preferred is a composition, which comprises
(i) a polyurethane foam or a polyether polyol,
(ii) a ternary stabilizer combination of a 3-Phenyl-benzofuran-2-one derivative, a bisphenolic stabilizer and an aliphatic phosphite ester as defined above,
(iii.1) preferably a first further additive, which is a technical mixture of aromatic amines obtained by the reaction of diphenylamine with diisobutylene (also commercially available as Irganox 5057™)
(iii.2) preferably a second further additive, which is octadecyl-3-(3,5-di-tert.butyl-4-hydroxyphenyl)-propionate] (commercially available as Irganox 1076™)

Preferred is a composition, which comprises
(i) a polyurethane foam or a polyether polyol,
(ii) a ternary stabilizer combination of a 3-Phenyl-benzofuran-2-one derivative, a bisphenolic stabilizer of formula (II.2-1) defined herein above and Di-n-Octyl Hydrogen Phosphite as aliphatic phosphite ester,
(iii) preferably a first further additive, which is 2,5,7,8-tetramethyl-2-[4,8,12-trimethyl-tridecyl]chroman-6-ol] (also known as vitamin E, e.g. commercially available as Irganox E 201™).

Preferred is a composition, which comprises
(i) a polyurethane foam or a polyether polyol,
(ii) a ternary stabilizer combination of a 3-Phenyl-benzofuran-2-one derivative, a bisphenolic stabilizer of formula (II.2-1) defined herein above and Di-n-Octyl Hydrogen Phosphite as aliphatic phosphite ester,
(iii) preferably a first further additive, which is a technical mixture of aromatic amines obtained by the reaction of diphenylamine with diisobutylene (also commercially available as Irganox 5057™).

Preferred is a composition, which comprises
(i) a polyurethane foam or a polyether polyol,
(ii) a ternary stabilizer combination of a 3-Phenyl-benzofuran-2-one derivative, a bisphenolic stabilizer of formula (II.2-1) defined herein above and Di-n-Octyl Hydrogen Phosphite as aliphatic phosphite ester,
(iii) preferably a first further additive, which is octadecyl-3-(3,5-di-tert.butyl-4-hydroxy-phenyl)-propionate] (commercially available as Irganox 1076™).

Preferred is a composition, which comprises
(i) a polyurethane foam or a polyether polyol,
(ii) a ternary stabilizer combination of a 3-Phenyl-benzofuran-2-one derivative, a bisphenolic stabilizer of formula (II.2-1) defined herein above and Di-n-Octyl Hydrogen Phosphite as aliphatic phosphite ester,
(iii.1) preferably a first further additive, which is 2,5,7,8-tetramethyl-2-[4,8,12-trimethyltridecyl]chroman-6-ol] (also known as vitamin E, e.g. commercially available as Irganox E 201™)
(iii.2) preferably a second further additive, which is a technical mixture of aromatic amines obtained by the reaction of diphenylamine with diisobutylene (also commercially available as Irganox 5057™).

Preferred is a composition, which comprises
(i) a polyurethane foam or a polyether polyol,
(ii) a ternary stabilizer combination of a 3-Phenyl-benzofuran-2-one derivative, a bisphenolic stabilizer of formula (II.2-1) defined herein above and Di-n-Octyl Hydrogen Phosphite as aliphatic phosphite ester,
(iii.1) preferably a first further additive, which is 2,5,7,8-tetramethyl-2-[4,8,12-trimethyl-tridecyl]chroman-6-ol] (also known as vitamin E, e.g. commercially available as Irganox E 201™)
(iii.2) preferably a second further additive, which is octadecyl-3-(3,5-di-tert.butyl-4-hydroxyphenyl)-propionate] (commercially available as Irganox 1076™)

Preferred is a composition, which comprises
(i) a polyurethane foam or a polyether polyol,
(ii) a ternary stabilizer combination of a 3-Phenyl-benzofuran-2-one derivative, a bisphenolic stabilizer of formula (II.2-1) defined herein above and Di-n-Octyl Hydrogen Phosphite as aliphatic phosphite ester,
(iii.1) preferably a first further additive, which is octadecyl-3-(3,5-di-tert.butyl-4-hydroxy-phenyl)-propionate] (commercially available as Irganox 1076™)
(iii.2) preferably a second further additive, which is a technical mixture of aromatic amines obtained by the reaction of diphenylamine with diisobutylene (also commercially available as Irganox 5057™

Preferred is a composition, which comprises
(a) a polyurethane foam or a polyether polyol,
(b) a ternary stabilizer combination of a 3-Phenyl-benzofuran-2-one derivative, a bisphenolic stabilizer and an aliphatic phosphite ester as defined above,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant, water, a surfactant and a catalyst.

In case of a polyurethane foam as component (i), it is possible that the composition is a part of a shaped article or the complete shaped article. Preferably, the composition is the complete shaped article, more preferably the composition is in case of a polyurethane foam a slabstock foam, most preferably a flexible slabstock foam.

Preferred is a composition, wherein the composition is in the form of a shaped article and component (i) is a polyurethane foam.

Preferred is a composition, wherein the composition is a part of a shaped article or the complete shaped article and component (i) is a polyurethane foam.

Preferred is a composition in the form of a foam, which comprises (i) a polyurethane foam and (ii) a stabilizer combination according to the present invention.

Preferred is a composition, which is a slabstock foam and comprises (i) a polyurethane foam and (ii) a stabilizer combination according to the present invention.

Examples for the shaped article are:
1) Floating devices for marine applications.
2) Automotive applications, in particular bumpers, dashboards, rear and front linings, moldings parts under the hood, hat shelf, trunk linings, interior linings, air bag covers, instrument panel, exterior linings, upholstery, interior and exterior trims, door panels, seat backing, exterior panels, cladding, pillar covers, chassis parts, convertible tops, front end module, pressed/stamped parts, side impact protection, sound deadener/insulator and sunroof.
3) Plane furnishings, Railway furnishings.
4) Devices for architecture and design, acoustic quietized systems, shelters.
5) Jacketing for other materials such as steel or textiles, for example cable-jacketing.
6) Electric appliances, in particular washing machines, tumblers, ovens (microwave oven), dish-washers, mixers.
7) Rotor blades, ventilators and windmill vanes, swimming pool covers, pool liners, pond liners, closets, wardrobes, dividing walls, slat walls, folding walls, roofs, shutters (e.g. roller shutters), sealings.
8) Packing and wrapping, isolated bottles.
9) Furniture in general, foamed articles (cushions, mattresses, impact absorbers), foams, sponges, dish clothes, mats.
10) Shoes, soles, insoles, spats, adhesives, structural adhesives, couches.

The above described preferences for a composition comprising a polyurethane foam or a polyether polyol as component (i), a stabilizer combination according to the present invention as component (ii). These preferences apply also to the further embodiments of the invention.

A further embodiment of the invention relates to a process for manufacturing a composition, which comprises the step of
incorporating a stabilizer combination according to the present invention as component (II) into a polyurethane foam or a polyether polyol as component (1) to obtain the composition.

The polyurethane foam is for example obtained by mixing the polyisocyanate reactant and the polyol reactant to receive the reaction mixture, which is permitted to react. It is possible to employ a two-step technique whereby all or a major portion of the polyol reactant is reacted with the polyisocyanate reactant in a first step to form an isocyanate-terminated prepolymer, which is then reacted with the remaining components in a second step to form a foam. However, it is preferred to employ a one-shot technique wherein all components are contacted and reacted in a single step.

Preferably, the process for manufacturing a composition comprises the step of
(a) premixing component (ii.1), component (ii.2) and component (iii.3) to a stabilizer combination (ii) as defined herein above;
(b) incorporating stabilizer combination I as component (ii) into a polyurethane foam, which comprises the steps of
   (b-F-1) adding the stabilizer combination (ii) to a starting mixture, which comprises a polyol reactant and is free of a polyisocyanate reactant to obtain a pre-reaction mixture,
   (b-F-2) adding a polyisocyanate reactant to the pre-reaction mixture to obtain the reaction mixture, and
   (b-F-3) reacting the reaction mixture to obtain the composition, which comprises the polyurethane foam, or incorporating stabilizer combination (ii) into a polyether polyol, which comprises the step of
   (b-P-1) adding the stabilizer combination (ii) to the polyether polyol to obtain the composition, which comprises the polyether polyol.

If added, a first further additive is preferably added prior to adding the polyisocyanate reactant, more preferably to the starting mixture or the pre-reaction mixture.

If added, a second further additive is preferably added prior to adding the polyisocyanate reactant, more preferably to the starting mixture or the pre-reaction mixture.

If added, water or a carboxylic acid is preferably added prior to adding the polyisocyanate reactant, more preferably to the starting mixture or the pre-reaction mixture. If added, a blowing agent is preferably added prior to adding a polyisocyanate reactant or parts or all of the blowing agent together with the polyisocyanate reactant.

If added, a surfactant is preferably added prior to adding the polyisocyanate reactant, more preferably to the starting mixture or the pre-reaction mixture.

If added, a catalyst is preferably added prior to adding the polyisocyanate reactant, more preferably to the starting mixture or the pre-reaction mixture.

If added, a crosslinker is preferably added prior to adding the polyisocyanate reactant, more preferably to the starting mixture or the pre-reaction mixture.

If added, a chain extender is preferably added prior to adding the polyisocyanate reactant, more preferably to the starting mixture or the pre-reaction mixture.

Preferred is a process for manufacturing a composition, which comprises the steps of incorporating stabilizer combination as component (ii) into a polyurethane foam or a polyether polyol as component (i) to obtain the composition.

A further embodiment of the invention relates to the use of a stabilizer combination, i.e. component (ii), for protecting a polyurethane foam or a polyether polyol, i.e. component (i), against degradation. Preferably, protecting is against oxidative, thermal or light-induced degradation. In case of a polyurethane foam as component (i), protecting is preferably against yellowing. In case of a polyurethane foam as component (i), protecting is preferably against scorching. In case of a polyether polyol as component (i), protecting is preferably against oxidative degradation, more preferably against degradation by oxygen at a temperature between 10° and 300° C.

Preferred is the use of stabilizer combination, i.e. component (ii), for protecting a polyurethane foam or a polyether polyol, i.e. component (i) against degradation.

Preferred is the use of stabilizer combination, i.e. component (ii), for protecting a polyurethane foam against scorching.

### EXAMPLES

The invention is illustrated by the non-limiting examples below.

In order to investigate the performance of di-octyl hydrogen phosphite in Polyether Polyol and PU foams, its activity as neat additive has been checked. In addition, its activity has been checked in combination with a high molecular weight sterically hindered phenol (example S-1 in WO17125291). Since WO17125291 reports synergistic combination of sterically hindered phenol and vitamin E at an overall concentration of 0.45% stabilizer composition, the same dosing has been used in the application examples described in this invention (Table T-A-1). Furthermore, its activity in combination with benzofuranones has been checked such as with compound 1-30 from EP 0871066 A1 and Stabilizer 4 from WO2020/002130. The latter describes the test of benzofuranones at overall concentration of 1%, therefore the same loading has been used in the application examples reported in this invention (Tables T-A-2, T-A-3).

Actually, di-octyl hydrogen phosphite did not show significant antioxidant activity and improvement in binary combinations with the above-mentioned stabilizers.

Surprisingly, an improved performance was instead detected when using di-octyl phosphite in a ternary combination with both sterically hindered phenol and a benzofuranone derivative (Table T-A-4). Such improvement was superior to the binary combination of sterically hindered phenol and benzofuranone derivatives already described in WO2020/002130.

After checking the anti-scorch activity of such combination, emissions on Polyol and PU foams have been tested as well. Gas fading discoloration and light-induced discoloration have been investigated too. Results are reported in the application examples, as well as results with the addition of further preferred additives as outlined herein above.

Anti-scorch systems are needed to prevent scorch during the production of flexible PU foams and they are usually introduced in Polyol, one of the main raw materials used for the process. Since polyol and more in particular polyether polyols are prone to thermal degradation, it is important that the anti-scorch system used also provides good stability to Polyol against thermal degradation which may occur during storage and transportation.

The propensity of Polyol to undergo thermal degradation can be easily measured by DSC, where the Polyol is exposed to increasing temperatures in the presence of oxygen until its auto-oxidation starts.

### Experimental Part

Unless the context suggests otherwise, percentages are always by weight. A reported content is based on the content in aqueous solution or dispersion if not stated otherwise.

Components of the stabilizer combinations:

| Component | Code | Stabilizer | Name or Source |
|---|---|---|---|
| component | | 3-phenyl-benzofuran-2-one | |
| (ii.1) | | | |
| | BF-1 | 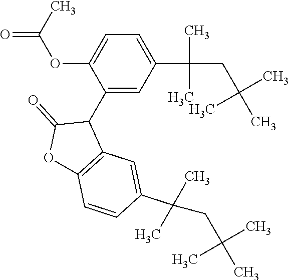 [SMILES: CC(=O)Oc1ccc(C(C)(C)CC(C)(C)C)cc1C1C(=O)Oc2ccc(C(C)(C)CC(C)(C)C)cc21] | Cpd. 1-30 in EP0871066 |
| | | IUPAC: [2-[2-oxo-5-(1,1,3,3-tetramethylbutyl)- | |
| | | 3H-benzofuran-3-yl]-4-(1,1,3,3-tetramethylbutyl) | |
| | | phenyl] acetate] | |
| | BF-2 | 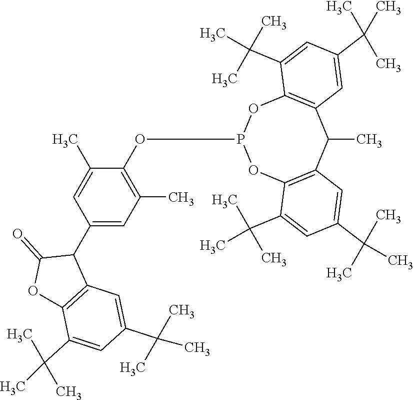 [SMILES: Cc1cc(C2C(=O)Oc3c2cc(C(C)(C)C)cc3C(C)(C)C)cc(C)c1OCP1Oc2c(cc(C(C)(C)C)cc2C(C)(C)C)C(C)c2cc(C(C)(C)C)cc(C(C)(C)C)c2O1] | Cpd 4 in WO2020/002130; or obtained according to example S-8 in WO 2015/121445 |
| | | IUPAC: [5,7-ditert-butyl-3-[3,5-dimethyl-4- | |
| | | [(1,3,7,9-tetratert-butyl-5-methyl-5H- | |
| | | benzo[d][1,3,2]benzodioxaphosphocin-11- | |
| | | yl)oxy]phenyl]-3H-benzofuran-2-one] | |
| component | | sterically hindered phenol | |
| (ii.2) | | | |
| | BP-1 | Bisphenolic stabilizer 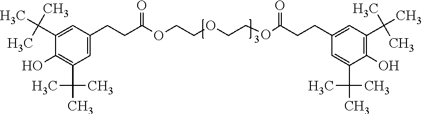 | Ex. S-1 in WO17125291 or obtained according to example 1a of WO 2010/003813 |
| | | IUPAC: 2-[2-[3-(3,5-ditert-butyl-4-hydroxy- | |
| | | phenyl)propanoyloxy]ethoxy]ethyl 3-(3,5-di- | |
| | | tert-butyl-4-hydroxy-phenyl)propanoate | |
| component | | aliphatic phosphorous (III) compound | |
| (ii.3) | | | |
| | AP-1 | di-octyl-hydrogen phosphite | commercially |
| | | | available as |
| | | | Dapraphos P 16 ™ |
| component | | chromanol stabilizer | |
| (iii.1) | | | |
| | CS-1 | 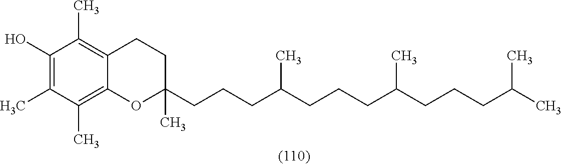 [SMILES: Cc1c(C)c2c(c(C)c1O)CCC(C)(CCCC(C)CCCC(C)CCCC(C)C)O2 ; "(110)"] | commercially available as Irganox E201 ™ |
| | | IUPAC: 2,5,7,8-tetramethyl-2-[4,8,12-trime- | |
| | | thyltridecyl]chroman-6-ol] | |
| component | | Mixture of aromatic aminic antioxidants (e.g. | |
| (iii.2) | | alkylated phenylarylamine) | |
| | AO-1 | obtained by the reaction of diphenylamine | commercially |
| | | with diisobutylene | available |
| | | | as Irganox |
| | | | 5057 ™ |
| component | | Phenolic antioxidant | |
| (iii.3) | | | |
| | PO-1 | 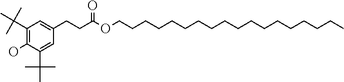 [SMILES: CCCCCCCCCCCCCCCCCCOC(=O)CCc1cc(C(C)(C)C)c(O)c(C(C)(C)C)c1] | commercially available as Irganox 1076 ™ |
| | | IUPAC: Octadecyl-3-(3,5-di-tert.butyl-4- | |
| | | hydroxyphenyl)-propionate | |

### Example 1—Stabilization of a Polyether/Polyurethane Soft Foam

The stabilizer composition according to table T-A-1 is dissolved in 116.8 g of a trifunctional Polyether Polyol predominantly containing secondary hydroxyl groups, with a molecular weight of 3500 Da, with OH Number=48 and containing no stabilizers. 10.98 g of a solution consisting of 2.40 g Tegostab BF 2370 (RTM Evonik Industries; surfactant based on polysiloxane), 0.18 g Tegoamin 33 (RTM Evonik Industries; general purpose gelling catalyst based on triethylene diamine) and 8.4 g of deionized water are added and the reaction mixture is stirred vigorously for 10 seconds at 2600 rpm. 0.36 g Kosmos 29 (RTM Evonik Industries; catalyst based on stannous octoate) dissolved with 3.24 g of Polyol are then added and the reaction mixture is again stirred vigorously for 18 hours at 1400 rpm. 99.24 g of isocyanate TDI 80 (mixture containing 80% toluene-2,4-diisocyanate and 20% toluylene-2,6-diisocyanate isomers) is then added with continuous stirring for 5 to 7 seconds at 2600 rpm. The mixture is then poured into a 20×20×20 cm plastic-box and an exothermic foaming reaction takes place as indicated by an increase of temperature. The foam buns are cooled and stored at room temperature for 24 hours.

All prepared foam buns show a comparable initial white colour and were use, unless otherwise specified, in the following examples.

### Examples A-1 to A-4: Anti-Scorch Testing

Scorch resistance is determined by static heat aging, i.e. static alu-block test. The foam buns are cut into thin cylinders (2 cm thick, 1.5 cm in diameter). From each foam bun, a thin cylinder is taken as foam sample. The foam sample is heated in an aluminum block. The temperature is kept for 30 min at the temperature of 190° C.

The scorch resistance is assessed by measuring the colour of the foam sample after aging. The measured colour is reported in terms of Yellowness Index (YI) determined on the foam sample in accordance with the ASTM D 1925-70 Yellowness Test. Low YI values denote little discoloration, high YI values severe discoloration of the samples. The whiter a foam sample remains, the better the foam sample is stabilized.

As the measure of scorch resistance, Delta YI was calculated as the difference between the discoloration of each foam formulation compared to the discoloration of the foam containing no additional antioxidants. Since a higher discoloration is measured in the foam containing no stabilizers, the calculation of Delta YI as below gives a negative number:

Delta YI=(Discoloration of the PU stabilized formulation)−(Discoloration of the PU non-stabilizer formulation)

The lower the value of the calculated Delta YI, the higher the anti-scorch performance.

### Example A-1

TABLE T-A-1
Results of static alublock ageing of polyurethane soft
foams: Delta YI after 30 min exposure at 190° C.

| | Single stabilizer or | Delta YI |
|---|---|---|
| | binary stabilizer combination | after 30 |
| Foam | (added parts based on 100 parts | min at |
| No. | polyether polyol in weight %) | 190° C. |
| A-1-1 ^{a)} | No anti-scorch stabilizers | 0 |
| A-1-2 ^{a)} | 0.45 wt % BP-1 | −22.1 |
| A-1-3 ^{a)} | 0.45 wt % AP-1 | 6.3 |
| A-1-4 ^{a)} | 0.225 wt % BP-1 with 0.225 wt % AP-1 | −17 |
| A-1-5 ^{a)} | 0.338 wt % BP-1 with 0.112 wt % AP-1 | −20.8 |
| A-1-6 ^{a)} | 0.394 wt % BP-1 with 0.056 wt % AP-1 | −21.7 |

Footnotes:
^{a)} comparative

As illustrated in table T-A-1, the use of the sterically hindered phenol stabilizer alone does show an anti-scorch performance, whereas the use of the aliphatic phosphorous (III) compound di-octyl hydrogen phosphite alone does even cause a higher discoloration compared to the control. The use of a binary 1:1 stabilizer combination having the same total concentration of stabilizers as the singly used stabilizer shows a weaker anti-scorch performance, meaning a higher Delta YI value, than the single use of the sterically hindered phenol stabilizer, and if the ratio is gradually modified in favor of a higher share of the sterically hindered phenol, an improvement of the anti-scorch performance is observed. However, still, the lowest Delta YI valuer is achieved when using the sterically hindered phenol alone.

### Example A-2

TABLE T-A-2
Results of static alublock ageing of polyurethane soft foams:
Delta YI after 30 min exposure at 190° C.

| | Single stabilizer or binary stabilizer | Delta YI after |
|---|---|---|
| Foam | combination (added parts based on | 30 min at |
| No. | 100 parts polyether polyol in weight %) | 190° C. |
| A-2-1 ^{a)} | No anti-scorch stabilizers | 0 |
| A-2-2 ^{a)} | 1 wt % BF-2 | −23.0 |
| A-2-3 ^{a)} | 1 wt % AP-1 | 12.5 |
| A-2-4 ^{a)} | 0.3 wt % BF-2 with 0.7 wt % AP-1 | −18.0 |
| A-2-5 ^{a)} | 0.5 wt % BF-2 with 0.5 wt % AP-1 | −21.9 |

Footnotes:
^{a)} comparative

As illustrated in table T-A-2, the use of the benzofuranone derivative stabilizer BF-2 alone does show an anti-scorch performance, whereas the use of the aliphatic phosphorous (III) compound di-octyl hydrogen phosphite alone does even cause a higher discoloration compared to the control. The use of a binary 1:1 stabilizer combination having the same total concentration of stabilizers as the singly used stabilizer shows a weaker anti-scorch performance, meaning a higher Delta YI value, than the single use of the benzofuranone derivative stabilizer BF-2, and if the ratio is modified to lower the share of the benzofuranone derivative, less anti-scorch performance is observed. The lowest Delta YI value is achieved when using the benzofuranone derivative alone.

### Example A-3

TABLE T-A-3
Results of static alublock ageing of polyurethane soft foams:
Delta YI after 30 min exposure at 190° C.

| | Single stabilizer or binary stabilizer | Delta YI |
|---|---|---|
| Foam | combination (added parts based on | after 30 min |
| No. | 100 parts polyether polyol in weight %) | exposure at 190° C. |
| A-3-1 ^{a)} | No anti-scorch stabilizers | 0 |
| A-3-2 ^{a)} | 1 wt % BF-1 | −19.1 |
| A-3-3 ^{a)} | 1 wt % AP-1 | 12.5 |
| A-3-4 ^{a)} | 0.5 wt % BF-1 with 0.5 wt % AP-1 | −19.2 |
| A-3-5 ^{a)} | 0.3 wt % BF-1 with 0.7 wt % AP-1 | −13.5 |

Footnotes:
^{a)} comparative

Similarly to what has been observed in table T-A-2, also in table T-A-3 relating to the use of another benzofuranone derivative stabilizer BF-1, for the binary 1:1 stabilizer combination having the same total concentration of stabilizers (example A-34) as the singly used benzofuranone BF-1 stabilizer (A-3-2), a weaker anti-scorch performance, meaning a higher Delta YI value for the use of the combination of di-octyl hydrogen phosphite with the second tested benzofuranone derivative BF-1 is observed, whereas the lowest Delta YI value is achieved when using the benzofuranone derivative alone.

### Example A-4

TABLE T-A-4.a
Results of static alublock ageing of polyurethane soft foams:
Delta YI after 30 min exposure at 190° C.

| | No stabilizer ^{a)}, or single/binary stabilizer ^{a)} | Delta YI |
|---|---|---|
| | or ternary ^{b)} stabilizer combination according | after 30 min |
| Foam | to the invention (added parts based on | exposure |
| No. | 100 parts polyether polyol in weight %) | at 190° C. |
| A-4-1 ^{a)} | No anti-scorch stabilizers | 0 |
| A-4-2 ^{a)} | 0.45 wt % BP-1 | −22.1 |
| A-4-3 ^{a)} | 0.45 wt % BF-2 | −19.7 |
| A-4-4 ^{a)} | 0.45 wt % AP-1 | 6.3 |
| A-4-5 ^{a)} | 0.40 wt % BP-1with 0.05 wt % BF-2 | −26.3 |
| A-4-6 ^{b)} | 0.35 wt % BP-1 + 0.05 wt % BF-2 + 0.05 wt % AP-1 | −27.6 |

Footnotes:
^{a)} comparative
^{b)} according to the invention

Table T-A-4a. illustrates how the binary combination of sterically hindered phenol and benzofuranone derivative shows an improved performance compared to the neat antioxidants used alone. And here, furthermore, when adding aliphatic di-octyl hydrogen phosphite to this binary combination, the resulting ternary combination gives a further improved performance.

TABLE T-A-4.b
Results of static alublock ageing of polyurethane soft foams:
Delta YI after 30 min exposure at 200° C.
Part I. Ternary ^{b)} stabilizer combination according to the present invention

| | No stabilizer or ternary ^{b)} stabilizer | |
|---|---|---|
| | combination according to the invention | Delta YI after 30 |
| Foam | (added parts based on 100 parts | min exposure at |
| No. | polyether polyol in weight %) | 200° C. |
| A-4b-1 ^{a)} | No anti-scorch stabilizers | 0 |
| A-4b-2 ^{b)} | 0.350 wt % BP1 + 0.050 wt % BF2 + 0.050 wt % AP1 | −31.0 |
| A-4b-3 ^{b)} | 0.350 wt % BP1 + 0.050 wt % BF1 + 0.050 wt % AP1 | −27.2 |

Part II. Ternary ^{b)} stabilizer combination according to the
present invention with further additives

| | No stabilizer or ternary ^{b)} stabilizer combination | Delta YI after |
|---|---|---|
| | according to the invention with further additives | 30 min |
| Foam | (added parts based on 100 parts | exposure at |
| No. | polyether polyol in weight %) | 200° C. |
| A-4b-1 ^{a)} | No anti-scorch stabilizers | 0 |
| A-4b-4 ^{b)} | 0.315 wt % BP1 + 0.045 wt % BF2 + 0.045 wt % | −28.2 |
| | AP1 + 0.045 wt % CS1 | |
| A-4b-5 ^{b)} | 0.315 wt % BP1 + 0.045 wt % BF1 + 0.045 wt % | −27.1 |
| | AP1 + 0.045% wt % CS1 | |
| A-4b-6 ^{b)} | 0.243% wt % BP1 + 0.036 wt % BF2 + 0.036 wt % | −29.7 |
| | AP1 + 0.135 wt % PO1 | |
| A-4b-7 ^{b)} | 0.243 wt % BP1 + 0.036 wt % BF1 + 0.036 wt % | −25.4 |
| | AP1 + 0.135 wt % PO1 | |
| A-4b-8 ^{b)} | 0.315 wt % BP1 + 0.045 wt % BF1 + 0.045 wt % | −27.7 |
| | AP1 + 0.045 wt % AO1 | |

notes:
^{a)} comparative
^{b)} according to the invention
Footnotes:
^{a)} comparative
^{b)} according to the invention

The data of table T-A-4b part I show that the ternary combinations according to the present invention provide high anti-scorch performance even at increased ageing temperature, and in part II it is shown that the achieved performance could be upheld or even improved by adding further preferred additives to the inventive ternary combination.

### Example A-5

### Oxidation Resistance Testing:

The oxidation resistance of the obtained stabilized polyether polyol samples is determined by differential scanning calorimetry (DSC). A sample is heated starting at 50° C. with a heating rate of 5° C./min under oxygen until 200° C. is reached. The appearance of an exothermic peak indicates the beginning of a thermo-oxidative reaction. The temperature at the onset of the exothermic peak is noted. A better stabilized sample is characterized by a higher temperature for the onset. The results are depicted in table T-A-5.

TABLE T-A-5
Oxidation resistance of stabilized polyether polyol
Part I. Ternary ^{b)} stabilizer combination according to the present invention

| | No stabilizer ^{a)} or ternary ^{b)} stabilizer combination | onset |
|---|---|---|
| | according to the invention | temper- |
| example | (added parts based on 100 parts | ature |
| No. | polyether polyol in weight %) | [° C.] |
| A-5-1 ^{a)} | No anti-scorch stabilizers | 130 |
| A-5-2 ^{b)} | 0.35 wt % BP-1 + 0.05 wt % BF-2 + 0.05 wt % AP-1 | 178 |
| A-5-3 ^{b)} | 0.35 wt % BP-1 + 0.05 wt % BF-1 + 0.05 wt % AP-1 | 177 |

Part II. Ternary ^{b)} stabilizer combination according
to the present invention with further additives

| | No stabilizer or ternary ^{b)} stabilizer combination | onset |
|---|---|---|
| | according to the invention | temper- |
| example | with further additives (added parts based | ature |
| No. | on 100 parts polyether polyol in weight %) | [° C.] |
| A-5-1 ^{a)} | No anti-scorch stabilizers | 130 |
| A-5-4 ^{b)} | 0.315 wt % BP-1 + 0.045 wt % BF-1 + | 187 |
| | 0.045 wt % AP-1 + 0.045 wt % AO-1 | |
| A-5-5 ^{b)} | 0.243 wt % BP-1 + 0.036 wt % BF-2 + | 178 |
| | 0.036 wt % AP-1 + 0.135 wt % PO-1 | |
| A-5-6 ^{b)} | 0.243 wt % BP-1 + 0.036 wt % BF-1 + | 176 |
| | 0.036 wt % AP-1 + 0.135 wt % PO-1 | |
| A-5-7 ^{b)} | 0.05 wt % BP-1 + 0.005 wt % BF-2 + | 175 |
| | 0.05 wt % AP-1 + 0.30 wt % PO-1 | |
| A-5-8 ^{b)} | 0.05 wt % BP-1 + 0.05 wt % BF-1 + | 175 |
| | 0.05 wt % AP-1 + 0.30 wt % PO-1 | |
| A-5-9 ^{b)} | 0.315 wt % BP1 + 0.045 wt % BF2/ | 192 |
| | 0.045 wt % AP1 + 0.045 wt % CS1 | |
| A-5-10 ^{b)} | 0.315 wt % BP1 + 0.045 wt % BF1 + | 194 |
| | 0.045 wt % AP1 + 0.045 wt % CS1 | |
| A-5-11^{b)} | 0.05 wt % BP-1 + 0.05 wt % BF-2 + 0.05 wt % | 183 |
| | AP-1 + 0.25 wt % PO-1 + 0.05 wt % CS-1 | |
| A-5-12 ^{b)} | 0.05 wt % BP-1 + 0.05 wt % BF-1 + 0.05 wt % | 193 |
| | AP-1 + 0.25 wt % PO-1 + 0.05 wt % CS-1 | |

Footnotes:
^{a)} comparative
^{b)} according to the invention

Table T-A-5 part I shows that the novel ternary combinations according to the present invention significantly increases the auto-oxidation temperature of Polyol, and part 11 show that the addition of further preferred additives may improve this effect even more

### Example A-6: Emissions Measurement in Polyol

Polyols, especially of polyether type, are prone to thermo-oxidative degradation leading to volatile side-products, including aldehydes.

Anti-scorch systems which can prevent degradation should play a role to the released volatile side-products too, reducing their quantity. Among emissions of volatile components, aldehydes are particularly critical due to their classification and contribution to odor. Especially in Asia, the industry refers to standards and regulations aiming to reduce the amount of volatile components of aldehyde type.

In this example, aldehydes released by Polyols are measured, comparing the values measured in Polyol without stabilizers and the values measured in Polyol containing the stabilized composition according to Table T-A-6.

Samples of Polymer Polyol (with OH number=25-32, solid content (Styrene, acrylonitrile) of 40-45%) without stabilizers and containing the stabilizer composition indicated in Table T-A-6 were analyzed to detect the released aldehydes by means of HPLC. Afterwards, the polyol samples have been heated up to 100° C. and kept at this temperature for 48 hours, then aldehydes have been measured. Results are depicted in Table T-A-6 (values in ppm):

TABLE T-A-6
Emissions measurement on Polyol

| | No stabilizer ^{a)} | | | | |
|---|---|---|---|---|---|
| | or ternary ^{b)} | | | | |
| | stabilizer | | | | |
| | combination | For- | Formalde- | Acetalde- | Acetal- |
| | (added parts based | malde- | hyde after | hyde | dehyde |
| | on 100 parts | hyde | heat | before | after |
| Foam | polyether polyol | before | expo- | expo- | heat ex- |
| No. | in weight %) | exposure | sure | sure | posure |
| A-6-1 ^{a)} | No anti-scorch | 0.67 | 4.11 | 4.96 | 58.84 |
| | stabilizers | | | | |
| A-6-2 ^{b)} | 0.078 wt % BP-1 + | 0.54 | 3.8 | 1.8 | 19.97 |
| | 0.011 wt % BF-1 + | | | | |
| | 0.011 wt % AP-1 | | | | |

Footnotes:
^{a)} comparative
^{b)} according to the invention

The results in table T-A-6 show that the addition to Polyol of the ternary stabilizer combination according to the present invention contributes to significantly reducing the level of the released aldehydes upon thermal ageing.

### Example A. 7: Emission Measurement in PU Foams

### Preparation of Polyether/Polyurethane Soft Foams:

The stabilizer composition according to table T-A-7 is dissolved in 217.3 g of a trifunctional Polyether Polyol predominantly containing secondary hydroxyl groups, with a molecular weight of 3500 Da, with OH Number=48 and containing no stabilizers. 11.00 g of a solution consisting of 4.40 g Tegostab BF 2370 (RTM Evonik Industries; surfactant based on polysiloxane), 0.33 g Tegoamin 33 (RTM Evonik Industries; general purpose gelling catalyst based on triethylene diamine) and 6.27 g of deionized water are added and the reaction mixture is stirred vigorously for 10 seconds at 2600 rpm. 0.26 g Kosmos 29 (RTM Evonik Industries, catalyst based on stannous octoate) dissolved with 2.38 g of Polyol are then added and the reaction mixture is again stirred vigorously for 18 hours at 1400 rpm. 92.4 g of isocyanate TDI 80 (mixture containing 80% toluene-2,4-diisocyanate and 20% toluylene-2,6-diisocyanate isomers) is then added with continuous stirring for 5 to 7 seconds at 2600 rpm. The mixture is then poured into a 20×20×20 cm plastic-box and an exo-thermic foaming reaction takes place as indicated by an increase of temperature. The foam buns are cooled and stored at room temperature for 24 hours. All prepared foam buns show a comparable initial white colour and were used in example 7.

### Emissions Measurement

On foam samples prepared according to the method above, emissions were measured according to the method VDA 278 10/11, which is a method widely used in the automotive industry to determine emissions from non-metallic materials used in vehicle interiors. Two cumulative values are determined, which estimate the emission of volatile organic compounds (VOC value) and the portion of condensable substances (FOG value). Furthermore, single substance emissions are determined. During the analysis, the samples are thermally extracted, and the emissions are separated by gas chromatography and detected by mass spectrometry. Results are expressed in ppm of volatile substances; the lower the values, the better. Maximum emissions levels accepted by the industry for emissions according to VDA 278 10/11 method may vary, however VOC emissions below 100 ppm and of FOG emissions below 250 ppm are considered good values.

The results are included in table T-A-7.

TABLE T-A-7
Emissions measured on PU foams according to VDA 278 10/11

| | Ternary ^{b)} stabilizer combination | | |
|---|---|---|---|
| Foam | (added parts based on 100 parts | VOC | FOG |
| No. | polyether polyol in weight %) | (ppm) | (ppm) |
| A-7-2 ^{b)} | 0.350 wt % BP-1 + 0.050 wt % | 21 | 66 |
| | BF-1 + 0.050 wt % AP-1 | | |

Footnote:
^{b)} according to the invention

Table T-A-7 shows how the foam stabilized with the novel stabilizer composition described in this invention gives emissions significantly lower than the thresholds considered critical in the industry.

### Example A-8—Stabilization of a Polyether/Polyurethane Soft Foam Against Gas Fading

### Preparation of Polyether/Polyurethane Soft Foams:

The stabilizer composition according to table T-A-8 is dissolved in 116.8 g of a trifunctional Polyether Polyol predominantly containing secondary hydroxyl groups, with a molecular weight of 3500 D, with OH Number=48 and containing no stabilizers. 10.98 g of a solution consisting of 2.40 g Tegostab BF 2370 (RTM Evonik Industries; surfactant based on polysiloxane), 0.18 g Tegoamin 33 (RTM Evonik Industries; general purpose gelling catalyst based on triethylene diamine) and 8.4 g of deionized water are added and the reaction mixture is stirred vigorously for 10 seconds at 2600 rpm. 0.36 g Kosmos 29 (RTM Evonik Industries; catalyst based on stannous octoate) dissolved with 3.24 g of Polyol are then added and the reaction mixture is again stirred vigorously for 18 seconds at 2600 rpm. 99.24 g of isocyanate TDI 80 (mixture containing 80% toluene-2,4-diisocyanate and 20% toluylene-2,6-diisocyanate isomers) is then added with continuous stirring for 5 to 7 seconds at 2600 rpm. The mixture is then poured into a 20×20×20 cm plastic-box and an exo-thermic foaming reaction takes place as indicated by an increase of temperature. The foam buns are cooled and stored at room temperature for 24 hours. All prepared foam buns show a comparable initial white colour and were used in examples 8 and 9.

### Exposure to NOx Gases

Gas fading resistance is an important secondary property for foams that during storage can undergo discoloration due to interaction with nitrogen oxides present in the atmosphere. Such attitude is determined by exposing the produced foam samples in a chamber with a controlled atmosphere, which contains 4-6 ppm of Nitrogen Oxide.

In the case of anti-scorch systems comprising the inventive ternary stabilizer combination of the present invention, it is important that they do not have a detrimental effect with regard to gas fading resistance of polyurethane flexible foams.

The gas fading resistance is assessed by measuring the color of the foam sample after exposure. The measured color is reported in terms of Yellowness Index (YI) determined on the foam sample in accordance with the ASTM 1926-70 Yellowness Test. Low YI values denote little discoloration, high YI values severe discoloration of the samples. The whiter a foam sample remains, the better the foam sample is stabilized.

Delta YI was calculated as a measure of gas fading resistance as the difference between the discoloration of each foam formulation compared to the discoloration of the foam containing no additional antioxidants. Since a higher discoloration is measured in the foam containing no stabilizers, the calculation of Delta YI as (Discoloration of the PU stabilized formulation−discoloration pf the PU non-stabilizer formulation) gives a negative number. The lower the calculated Delta YI, the better the performance.

In Table T-A-8, discoloration upon nitrogen oxide exposure is depicted, for the ternary stabilizer combinations object of this invention, as well as these ternary stabilizer combinations with the addition of further additives.

TABLE T-A-8
Results of NOx exposure of polyurethane soft foams
Part I. Ternary ^{b)} stabilizer combination according to the present invention

| | No stabilizer ^{a)} or ternary ^{b)} stabilizer combination | Delta YI |
|---|---|---|
| | according to the invention | after 30 |
| Foam | (added parts based on 100 parts | min NOx |
| No. | polyether polyol in weight %) | exposure |
| A-8-1 ^{a)} | No anti-scorch stabilizers | 0 |
| A-8-2 ^{b)} | 0.35 wt % BP-1 + 0.05 wt % BF-1 + 0.05 wt % AP-1 | −5.2 |
| A-8-3 ^{b)} | 0.35 wt % BP-1 + 0.05 wt % BF-2 + 0.05 wt % AP-1 | −4.8 |

Part II. Ternary ^{b)} stabilizer combination according
to the present invention with further additives

| | No stabilizer ^{a)} or ternary ^{b)} stabilizer combination | Delta YI |
|---|---|---|
| | according to the invention with further additives | after 30 |
| Foam | (added parts based on 100 parts | min NOx |
| No. | polyether polyol in weight %) | exposure |
| A-8-1 ^{a)} | No anti-scorch stabilizers | 0 |
| A-8-4 ^{b)} | 0.315 wt % BP-1 + 0.045 wt % BF-1 + 0.045 wt % | −3.9 |
| | AP-1 + 0.045 wt % AO-1 | |
| A-8-5 ^{b)} | 0.243 wt % BP-1 + 0.036 wt % BF-2 + 0.036 wt % | −4.5 |
| | AP-1 + 0.135 wt % PO-1 | |
| A-8-6 ^{b)} | 0.243 wt % BP-1 + 0.036 wt % BF-1 + 0.036 wt % | −4.8 |
| | AP-1 + 0.135 wt % PO-1 | |
| A-8-7 ^{b)} | 0.315 wt % BP1 + 0.045 wt % BF2/0.045 wt % | −5.1 |
| | AP1 + 0.045 wt % CS1 | |
| A-8-8 ^{b)} | 0.315 wt % BP1 + 0.045 wt % BF1 + 0.045 wt % | −4.0 |
| | AP1 + 0.045 wt % CS1 | |

Footnotes:
^{a)} comparative
^{b)} according to the invention

Table T-A-8 part I shows that the ternary stabilizer combinations according to the present invention decrease the discoloration effect under NOx exposure, thereby increasing the gas fading resistance of the exposed foams, and in part II it shows that this effect is largely upheld in the presence of further preferred additives.

### Example A-9—Stabilization of a Polyether/Polyurethane Soft Foam Against Weathering

### Exposure to Xenon Lamp

Polyurethane Foams widely used on the market are based on aromatic isocyanate and as such tend to discolor under exposure to light during storage and end use. Such characteristic is determined under laboratory conditions by exposing the produced foam samples in a chamber with controlled temperature and humidity, and with a light source mimicking sunlight radiation. For this purpose, Xenon lamps are widely used in accelerated so-called “Weathering” due to the similarity of their light spectrum to the sunlight spectrum.

The light-induced discoloration is assessed by measuring the color of the foam sample after exposure to Xenon Lam with an irradiation of 0.36 W/m² nm, measured at 340 nm wavelength, with a Black Panel Temperature of 63° C.+/−3° C., a chamber temperature of 42° C.+/−4° C. and a chamber relative humidity of 50%+/−5%, with continuous light exposure.

For anti-scorch systems comprising the inventive ternary stabilizer combination of the present invention, it is important that they do not affect the light-induced discoloration of polyurethane flexible foams.

The measured color is reported in terms of Yellowness Index (YI) determined on the foam sample in accordance with the ASTM 1926-70 Yellowness Test. Low YI values denote little discoloration, high YI values severe discoloration of the samples. The whiter a foam sample remains, the better the foam sample is stabilized.

Delta YI was calculated as a measure of light-induced discoloration as the difference between the discoloration of each foam formulation compared to the discoloration of the foam containing no additional antioxidants. Since a higher discoloration is measured in the foam containing no stabilizers, the calculation of Delta YI as (Discoloration of the PU stabilized formulation−discoloration pf the PU non-stabilizer formulation) gives a negative number. The lower the calculated Delta YI, the better the performance.

TABLE T-A-9
Results of Xenon Lamp exposure
of polyurethane soft foams

| Part I. Ternary ^{b)} stabilizer combination | | |
|---|---|---|
| according to the present invention | | |
| | | Delta YI |
| | No stabilizer ^{a)} or ternary ^{b)} stabilizer | after 8 hours |
| | combination according to the invention | of Xenon |
| Foam | (added parts based on 100 parts | Lamp |
| No. | polyether polyol in weight %) | exposure |
| A-9-1 ^{a)} | No anti-scorch stabilizers | 0 |
| A-9-2 ^{b)} | 0.35 wt % BP-1 + 0.05 wt % | −11.5 |
| | BF-1 + 0.05 wt % AP-1 | |
| A-9-3 ^{b)} | 0.35 wt % BP-1 + 0.05 wt % | −12.1 |
| | BF-2 + 0.05 wt % AP-1 | |
| Part II. Ternary ^{b)} stabilizer combination according | | |
| to the present invention with further additives | | |
| | No stabilizer ^{a)} or ternary ^{b)} | Delta YI after |
| | stabilizer combination | |
| | according to the invention | |
| | with further additives | 8 hours of |
| Foam | (added parts based on 100 parts | Xenon Lamp |
| No. | polyether polyol in weight %) | exposure |
| A-9-1 ^{a)} | No anti-scorch stabilizers | 0 |
| A-9-4 ^{b)} | 0.315 wt % BP-1 + 0.045 wt % BF-1 + | −8.9 |
| | 0.045 wt % AP-1 + 0.045 wt % AO-1 | |
| A-9-5 ^{b)} | 0.243 wt % BP-1 + 0.036 wt % BF-2 + | −9.9 |
| | 0.036 wt % AP-1 + 0.135 wt % PO-1 | |
| A-9-6 ^{b)} | 0.243 wt % BP-1 + 0.036 wt % BF-1 + | −8.7 |
| | 0.036 wt % AP-1 + 0.135 wt % PO-1 | |
| A-9-7 ^{b)} | 0.315 wt % BP1 + 0.045 wt % BF2/ | −11.5 |
| | 0.045 wt % AP1 + 0.045 wt % CS1 | |
| A-9-8 ^{b)} | 0.315 wt % BP1 + 0.045 wt % BF1 + | −10.3 |
| | 0.045 wt % AP1 + 0.045 wt % CS1 | |

Footnotes:
^{a)} comparative
^{b)} according to the invention

Table T-A-9 part I shows that the ternary stabilizer combinations according to the present invention significantly decrease the discoloration of the exposed foams, and in part II it shows that this effect is largely upheld in the presence of further preferred additives.

1.-24. (canceled)

25. A composition, which comprises the components
(i) a polyether polyol or a polyurethane foam; and
(ii) a ternary stabilizer combination comprising
component (ii.1): at least one 3-phenyl-benzofuran-2-one derivative,
selected from compound of formula (I.1-1), (I.1-2), (I.1-3), (I.1-4) or (I.1-5) 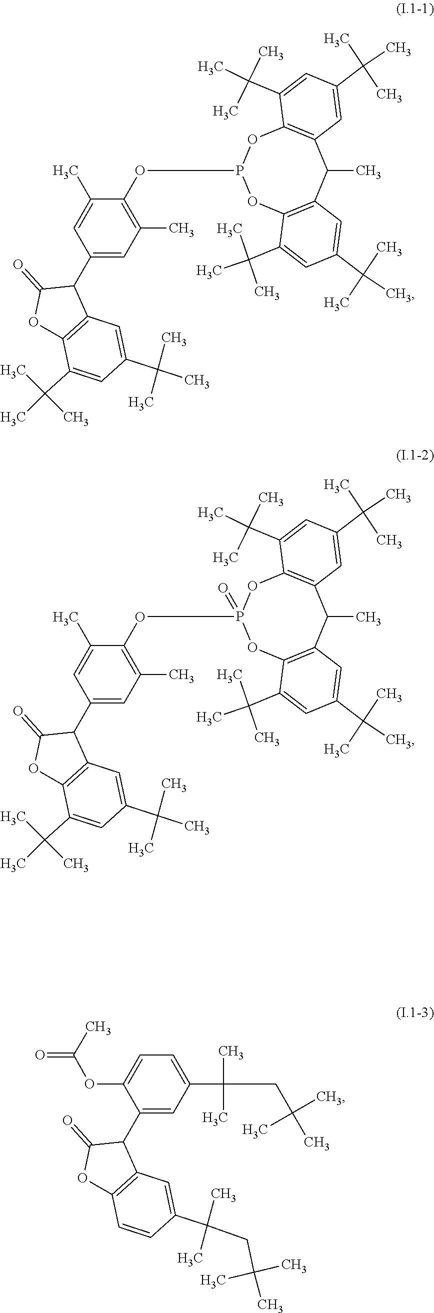 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)C(C)c2cc(C(C)(C)C)cc(C(C)(C)C)c2O1 ; Cc1cc(C2C(=O)Oc3c2cc(C(C)(C)C)cc3C(C)(C)C)cc(C)c1OP1(=O)Oc2c(cc(C(C)(C)C)cc2C(C)(C)C)C(C)c2cc(C(C)(C)C)cc(C(C)(C)C)c2O1 ; CC(=O)Oc1ccc(C(C)(C)CC(C)(C)C)cc1C1C(=O)Oc2ccc(C(C)(C)CC(C)(C)C)cc21] 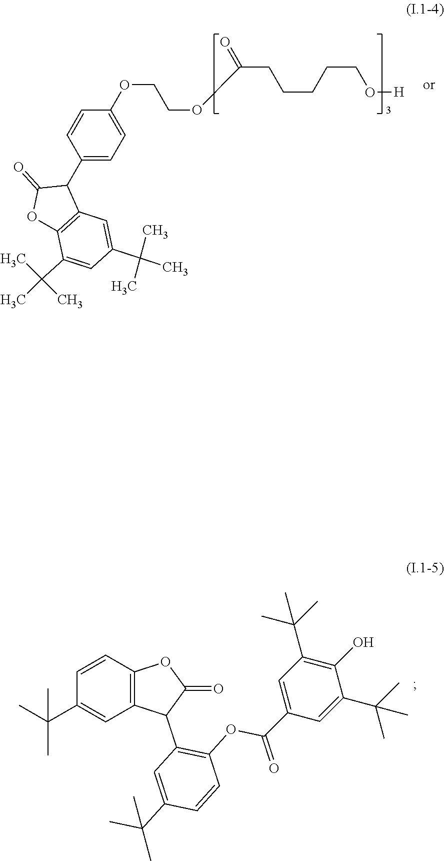
component (ii.2): at least one sterically hindered phenol stabilizer derivative, which is a bisphenolic stabilizer compound of formula (II) 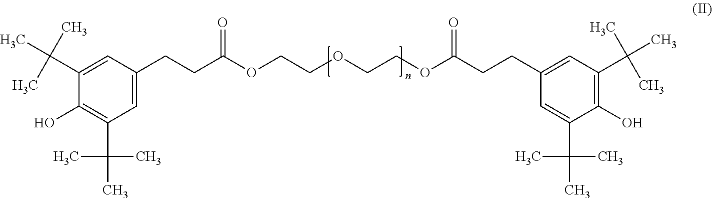
wherein
n is 1, 2, 3, 4, 5, 6, 7, 8, 9, 10 or 11.
and
component (ii.3): at least one aliphatic phosphite or phosphonate ester of at least one aliphatic alcohol, which aliphatic alcohol moiety has at least one primary hydroxyl group.

26. A composition according to claim 25, wherein the component (i) is a polyether polyol or a polyurethane foam, which is obtained by a polymerizing reaction of starting materials comprising a polyether polyol as one starting material.

27. A composition according to claim 25, wherein component (i) is a polyurethane foam.

28. A composition according to claim 25 wherein the polyurethane foam is obtained from the reaction of a polyisocyanate reactant and a polyol reactant in a reaction mixture, and the amount of the stabilizer combination (ii) is in case of the polyurethane foam from 0.01 to 10 parts by weight based on 100 parts by weight of the polyol reactant and in case of a polyether polyol from 0.01 to 10 parts by weight based on 100 parts by weight of the polyether polyol.

29. A composition according to claim 25, wherein
the 3-phenyl-benzofuran-2-one derivative is a substituted compound of formula (I.1-3)

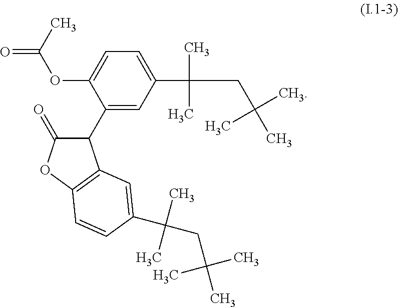 [SMILES: CC(=O)Oc1ccc(C(C)(C)CC(C)(C)C)cc1C1C(=O)Oc2ccc(C(C)(C)CC(C)(C)C)cc21]

30. A composition according to claim 25, wherein
component (ii.2) of the stabilizer combination (ii) is a is a bisphenolic stabilizer compound of formula II.2-1

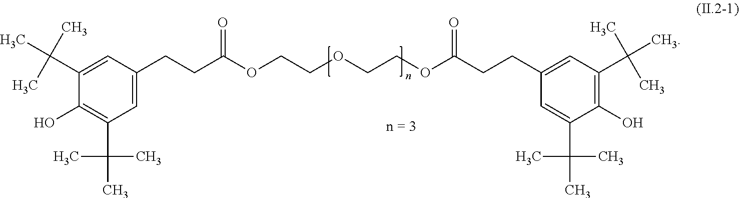

31. A composition according to claim 25, wherein
component (ii.3) of the stabilizer combination (ii) is a phosphite, which is a diester of two aliphatic alcohols having at least one primary hydroxyl group on their aliphatic alcohol moiety.

32. A composition according to claim 31, wherein
component (ii.3) of the stabilizer combination (ii) is Di-n-Octyl Hydrogen Phosphite.

33. A composition according to claim 29, wherein the weight ratio between component (ii.1), component (ii.2) and component (ii.3) is from 1:2:1 to 1:30:1.

34. A composition according to claim 29, wherein the weight ratio of the components (ii.1) and (ii.2) is from 1:10 to 3:1.

35. A composition according to claim 25, which comprises additionally
(iii) at least one further additive selected
from the group of chromanol-containing antioxidants such as tocopherols antioxidants such as-a-tocopherol, b-tocopherol, g-tocopherol, d-tocopherol and mixtures thereof (vitamin E), vitamin E acetate; and/or
from the group of aromatic aminic antioxidants such as a phenylarylamine, wherein the amine is only substituted with a phenyl and an C₆-C₁₀-aryl and the phenyl or the C₆-C₁₀-aryl is alkylated; and/or
from the group of esters of 3,5-di-tert-butyl-4-hydroxyphenyl acetic acid with mono- or polyhydric alcohols, such as methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2,2,2]octane.

36. A composition according to claim 35, comprising as further additive
(iii) at least one chromanol stabilizer of formula III 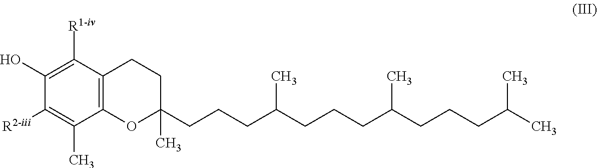
wherein
R¹⁻ⁱⁱⁱ and R²⁻ⁱⁱⁱ are independently of each other H or methyl.

37. A composition according to claim 35, comprising as further additive
(iii) at least a mixture of phenylarylamines as aromatic aminic antioxidant, which is obtained by the reaction of diphenylamine with diisobutylene, and which comprises 4-tert-butyldiphenylamine, 4-tert-octyldiphenylamine, 4,4′-di-tert-butyldiphenylamine, 2,4,4′-tris-tert-butyldiphenylamine, 4-tert-butyl-4′-tert-octyldiphenylamine, o,o′, m,m′, or p,p′-di-tert-octyldiphenylamine, 2,4-di-tert-butyl-4′-tert-octyldiphenylamine, 4,4′-di-tert-octyldiphenylamine and 2,4-di-tert-octyl-4′-tert-butyldiphenylamine.

38. A composition according to claim 35, comprising as further additive
(iii) at least the ester of alpha-(3,5-di-tert-butyl-4-hydroxyphenyl)propionic acid with octadecanol of formula (V) below.

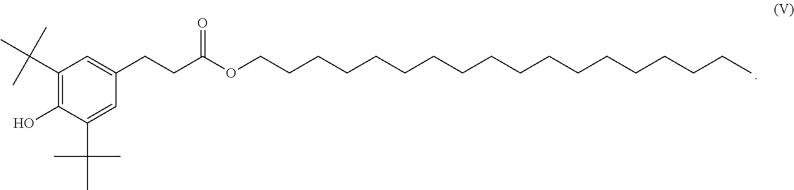 [SMILES: CCCCCCCCCCCCCCCCCCOC(=O)CCc1cc(C(C)(C)C)c(O)c(C(C)(C)C)c1]

39. A process for manufacturing a composition as defined in claim 25, which comprises the step of
(a) premixing component (ii.1), component (ii.2) and component (iii.3) to a stabilizer combination (ii) as defined in claim 25; and
(b) incorporating stabilizer combination (ii) into a polyurethane foam or a polyether polyol as defined in claim 25 as component (i) to obtain the composition as defined in claim 25.

40. Use of a stabilizer combination (ii) as defined in claim 25 as component (ii) for protecting a polyurethane foam or a polyether polyol as defined in claim 25 as component (i) against degradation.
